(19) United States
(12) Patent Application Publication
(10) Pub. No.: US 2008/0170486 A1
(43) Pub. Date: Jul. 17, 2008

(54) Optical Pickup Device

(76) Inventors: Makoto Sato, Saitama (JP); Masakazu Ogasawara, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/885,504

(22) PCT Filed: Feb. 28, 2006
(86) PCT No.: PCT/JP2006/304192

§ 371 Date: Oct. 24, 2007

(30) Foreign Application Priority Data
Mar. 1, 2005 (JP) 2005-055999

(51) Int. Cl. G11B 7/135; G11B 7/09; G11B 7/0065; G11B 7/125

(52) U.S. Cl. 369/112.05; 369/112.16

(57) ABSTRACT

An optical pickup device is constituted to enable stable recording or reproduction on/from a recording medium. The optical pickup device has an irradiation optical system for condensing a light beam using an objective lens, and comprises: a reflection portion disposed opposite the irradiation optical system, on a common optical axis therewith, and at a remove therefrom, for reflecting and returning the light beam toward the irradiation optical system; a phase plate disposed on the optical axis, for generating light on the optical axis, and light having a modified polarization state on all or a part of the periphery of the light on the optical axis, separately from the light beam; a detection optical system disposed on the optical axis, for extracting the light having a modified polarization state from return light of the light beam and guiding the extracted light to a photodetector; and a reflection portion driving portion for positioning the reflection portion on the basis of a photoelectric conversion output from the photodetector.

### TECHNICAL FIELD

The present invention relates to an optical pickup device for recording information on a recording medium such as an optical disk or an optical card on which information recording or information reproduction is performed optically, and more particularly to an optical pickup device (a pickup) for performing opposing light irradiation.

### BACKGROUND ART

A technique for recording a hologram volumetrically in a recording medium by performing irradiation from one side of a recording layer in a substantially identical position to a reflection layer while converging the emitted light to a minimum diameter is known in the prior art (see Japanese Patent Kokai No. 2004-171611 (Patent Document 1)). In this prior art, during recording, reference light and signal light are guided to an objective lens OB on the same axis so as to overlap each other, as shown in FIG. 1. The reference light and signal light, which are condensed by the objective lens OB, are in a state of constant interference on the optical axis. Hence, as shown in FIG. 1, when a recording medium is disposed such that a reflection layer thereof is disposed in a focal point position of the signal light, the reference light and signal light reciprocate through the recording medium so as to record a hologram. The reference light also reciprocates through the recording medium during reproduction such that the reflected reference light returns to the objective lens OB together with reproduction light.

As shown in FIG. 2, four specific types of hologram recording are performed, namely hologram recording A (reflected reference light and reflected signal light), hologram recording B (input reference light and reflected signal light), hologram recording C (reflected reference light and input signal light), and hologram recording D (input reference light and input signal light). Four types of hologram are also reproduced, namely hologram recording A (read by the reflected reference light), hologram recording B (read by the input reference light), hologram recording C (read by the reflected reference light), and hologram recording D (read by the input reference light). Since all of the beams (the input light and reflected light of the reference light and the input light and reflected light of information light) interfere in the recording layer, a plurality of holograms are recorded and reproduced. This is described in paragraphs (0096) and (0097) of Patent Document 1, for example.

Hence, with the conventional method of Patent Document 1, when a hologram is recorded on a reflection type recording medium, four holograms are recorded due to interference between four luminous fluxes, namely the input and reflected reference light and the input and reflected signal light, and as a result, the capacity of the recording medium is used wastefully. Accordingly, the reference light is reflected by the signal light of the recording medium during information reproduction, and must therefore be separated from the reproduction light from the reproduced hologram. This leads to deterioration of the reproduction signal reading performance.

On the other hand, a technique for recording a hologram volumetrically in a recording medium is known as prior art for solving this problem (see Japanese Patent Kokai No. 2002-123948 (Patent Document 2)). In this technique, an objective lens is disposed on the opposite side of a transmission recording medium to an objective lens for emitting a reference light, as shown in FIG. 3, and the reference light and information light that has passed through a spatial light modulator are emitted onto the recording medium coaxially and in identical positions but from opposite surface sides while being converged to a minimum diameter.

In this prior art, the information light is generated by the spatial light modulator during recording by spatially modulating light according to information to be recorded. The information light is condensed by the opposing objective lens and emitted onto the recording medium. The recording reference light is condensed by the objective lens and emitted onto the recording medium. In an information recording layer, the information light and the recording reference light interfere with each other to form an interference pattern, and the interference pattern is volumetrically recorded in the information recording layer. During reproduction, only the reference light is emitted onto the recording medium by the objective lens.

### DISCLOSURE OF THE INVENTION

In the technique of Patent Document 2, it is difficult to separate the reference light and reproduction light during reproduction. This is because a pair of objective lenses is disposed on either side of the recording medium, and the reference light and reproduction light that converge in the same focal point from the respective objective lenses overlap when condensed on the recording medium.

Further, with this conventional method, the spherical wave reference light and reproduction light are condensed at a single point, and therefore the intersection angle at which the two beams intersect is 180 degrees. As a result, the angle selectivity is large, which is unsuitable for high density recording through shift multiplexing. Furthermore, the objective lenses and the recording medium must be positioned accurately. In addition, the relative gap between the two objective lenses must also be maintained accurately, and as a result, the objective lens driving system and servo system become complicated.

Hence, an example of a problem to be solved by the present invention is to provide an optical pickup device in which recording or reproduction on/from a recording medium can be performed with stability.

An optical pickup device according to the present invention has an irradiation optical system for condensing a light beam using an objective lens, and comprises: a reflection portion disposed opposite the irradiation optical system, on a common optical axis therewith, and at a remove therefrom, for reflecting and returning the light beam toward the irradiation optical system; a phase plate disposed on the optical axis, for generating light on the optical axis, and light having a modified polarization state on all or a part of the periphery of the light on the optical axis, separately from the light beam; a detection optical system disposed on the optical axis, for extracting the light having a modified polarization state from return light of the light beam and guiding the extracted light to a photodetector; and a reflection portion driving portion for positioning the reflection portion on the basis of a photoelectric conversion output from the photodetector.

A light beam position control method according to the present invention is employed in an optical pickup device having an irradiation optical system for condensing a light beam using an objective lens, and comprises the steps of: disposing a reflection portion for reflecting and returning a light beam toward the irradiation optical system opposite the irradiation optical system, on a common optical axis therewith, and at a remove therefrom; generating separately, from the light beam, a central light component that passes through the optical axis, and a peripheral light component having a different polarization state to the central light component from all or a part of the periphery of the central light component, respectively; extracting the peripheral light component from return light of the optical beam and guiding the extracted peripheral light component to a photodetector; and positioning the reflection portion on the basis of a photoelectric conversion output from the photodetector.

### BRIEF DESCRIPTION OF THE DRAWINGS

FIG. 1 is a schematic partial sectional view of an objective lens and a hologram recording medium, illustrating conventional hologram recording;

FIG. 2 is a schematic partial sectional view of a hologram recording medium, illustrating conventional hologram recording;

FIG. 3 is a schematic partial sectional view of an objective lens, a hologram recording medium, and a spatial light modulation device, illustrating conventional hologram recording;

FIG. 4 is a schematic partial sectional view of an objective lens, a hologram recording medium, and a spatial light modulation device, illustrating hologram recording in a hologram device according to an embodiment of the present invention;

FIG. 5 is a schematic partial sectional view of an objective lens, a hologram recording medium, and a spatial light modulation device, illustrating hologram recording according to the present invention;

FIG. 6 is a schematic perspective view showing a spatial light modulator in a hologram device according to an embodiment of the present invention;

FIG. 7 is a schematic perspective view showing a spatial light modulator in a hologram device according to another embodiment of the present invention;

FIG. 8 is a schematic partial sectional view of an objective lens, a hologram recording medium, and a spatial light modulation device, illustrating hologram recording in a hologram device according to another embodiment of the present invention;

FIG. 9 is a schematic partial sectional view of an objective lens, a hologram recording medium, and a spatial light modulation device, illustrating hologram recording in a hologram device according to another embodiment of the present invention;

FIG. 10 is a schematic partial sectional view of an objective lens, a hologram recording medium, and a spatial light modulation device, illustrating hologram recording in a hologram device according to another embodiment of the present invention;

FIG. 11 is a schematic partial sectional view of an objective lens, a hologram recording medium, and a spatial light modulation device, illustrating hologram reproduction in a hologram device according to an embodiment of the present invention;

FIG. 12 is a schematic partial sectional view of an objective lens, a hologram recording medium, and a spatial light modulation device, illustrating hologram reproduction in a hologram device according to another embodiment of the present invention;

FIG. 13 is a schematic partial sectional view of an objective lens, a hologram recording medium, and a spatial light modulation device, illustrating hologram reproduction in a hologram device according to another embodiment of the present invention;

FIG. 14 is a partially cut-away schematic perspective view showing a spatial light modulation device in a hologram device according to an embodiment of the present invention;

FIG. 15 is a schematic partial sectional view of an objective lens, a hologram recording medium, and a spatial light modulation device, illustrating hologram recording in a hologram device according to another embodiment of the present invention;

FIG. 16 is a schematic partial sectional view of an objective lens, a hologram recording medium, and a spatial light modulation device, illustrating hologram recording in a hologram device according to another embodiment of the present invention;

FIG. 17 is a schematic constitutional diagram illustrating a reference light optical system and a signal light optical system in the main parts of a hologram device according to another embodiment of the present invention;

FIG. 18 is a schematic constitutional diagram illustrating a hologram device according to another embodiment of the present invention;

FIG. 19 is a schematic perspective view illustrating a reference light optical system and a signal light optical system in the main parts of a hologram device according to another embodiment of the present invention;

FIG. 20 is a schematic partial sectional view of an objective lens, a hologram recording medium, and a spatial light modulation device, illustrating hologram recording in a hologram device according to another embodiment of the present invention;

FIG. 21 is a schematic partial sectional view of an objective lens, a hologram recording medium, and a spatial light modulation device, illustrating hologram recording in a hologram device according to another embodiment of the present invention;

FIG. 22 is a schematic constitutional diagram illustrating a reference light optical system and a signal light optical system in the main parts of a hologram device according to another embodiment of the present invention;

FIG. 23 is a block diagram showing the schematic constitution of a hologram device for recording or reproducing information on/from a recording medium according to an embodiment of the present invention;

FIG. 24 is a schematic constitutional diagram showing the main parts of a pickup in a hologram device for recording or reproducing information on/from a recording medium according to an embodiment of the present invention;

FIG. 25 is a partially cut-away schematic perspective view showing an objective lens assembly in a pickup of a hologram device according to an embodiment of the present invention;

FIG. 26 is a schematic perspective view showing an outline of a three-axis actuator for a spatial light modulation device in a pickup of a hologram device according to an embodiment of the present invention;

FIG. 27 is a schematic partial sectional view of an objective lens, a hologram recording medium, and a spatial light modulation device, illustrating hologram recording in a hologram device according to another embodiment of the present invention;

FIG. 28 is a schematic partial sectional view of an objective lens, a hologram recording medium, and a spatial light modulation device, illustrating hologram recording in a hologram device according to another embodiment of the present invention;

FIG. 29 is a partial sectional view showing a disk-shaped hologram recording medium in a hologram device according to an embodiment of the present invention;

FIG. 30 is a plan view showing a light reception portion of an objective servo photodetector in a pickup of a hologram device for recording and reproducing information on/from a recording medium, according to an embodiment of the present invention;

FIG. 31 is a front view of a light reception portion seen from the optical axis, illustrating a light reception portion of a reflection servo photodetector in a pickup of a hologram device for recording and reproducing information on/from a recording medium, according to an embodiment of the present invention;

FIG. 32 is a schematic perspective view showing an outline of a pickup in a hologram device according to another embodiment of the present invention;

FIG. 33 is a schematic partial sectional view illustrating the position of a phase plate in a hologram device according to another embodiment of the present invention;

FIG. 34 is a schematic partial sectional view illustrating the position of a phase plate in a hologram device according to another embodiment of the present invention;

FIG. 35 is a schematic perspective view illustrating the form of a phase plate in a hologram device according to another embodiment of the present invention;

FIG. 36 is a schematic perspective view illustrating the form of a phase plate in a hologram device according to another embodiment of the present invention;

FIG. 37 is a front view of a phase plate seen from the optical axis, illustrating the form of a phase plate in a hologram device according to another embodiment of the present invention;

FIG. 38 is a front view of a light reception portion seen from the optical axis, illustrating a light reception portion of a reflection servo photodetector in a pickup of a hologram device for recording and reproducing information on/from a recording medium, according to another embodiment of the present invention;

FIG. 39 is a front view of a phase plate seen from the optical axis, illustrating the form of a phase plate in a hologram device according to another embodiment of the present invention;

FIG. 40 is a front view of a phase plate seen from the optical axis, illustrating the form of a phase plate in a hologram device according to another embodiment of the present invention;

FIG. 41 is a front view of a light reception portion seen from the optical axis, illustrating a light reception portion of a reflection servo photodetector in a pickup of a hologram device for recording and reproducing information on/from a recording medium, according to another embodiment of the present invention;

FIG. 42 is a front view of a light reception portion seen from the optical axis, illustrating a light reception portion of a reflection servo photodetector in a pickup of a hologram device for recording and reproducing information on/from a recording medium, according to another embodiment of the present invention;

FIG. 43 is a constitutional diagram showing an outline of a pickup in a hologram device according to another embodiment of the present invention;

FIG. 44 is a front view seen from the optical axis of a servo detection spatial light modulator in a pickup of a hologram device according to another embodiment of the present invention; and

FIG. 45 is a front view seen from the optical axis of a signal detection compound optical detection device in a pickup of a hologram device according to another embodiment of the present invention.

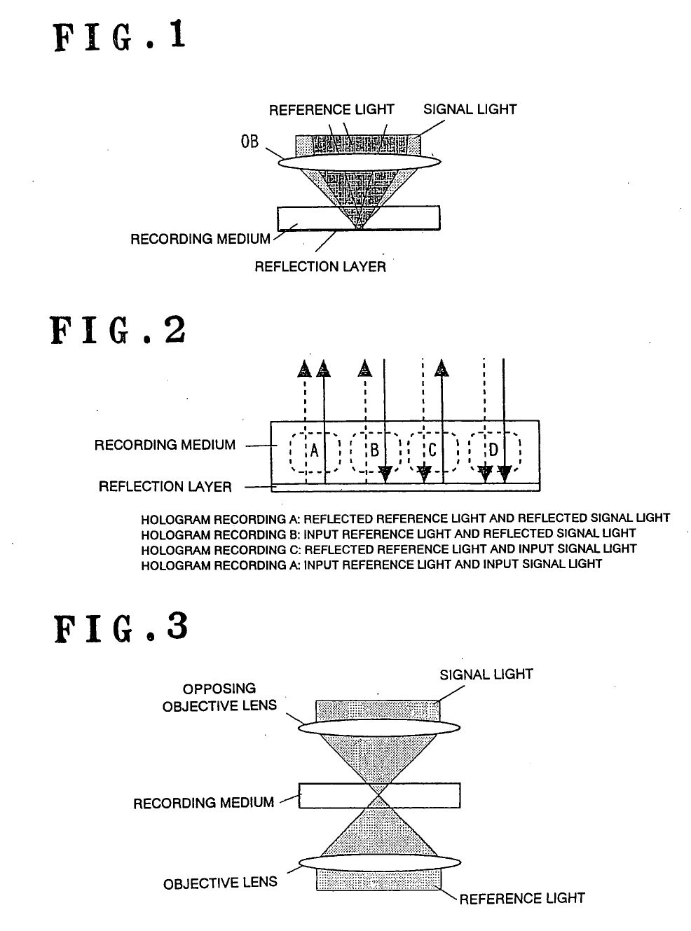

### BEST MODE FOR CARRYING OUT THE INVENTION

Embodiments of the present invention will be described below with reference to the drawings. Note that although an optical pickup device relating to hologram recording will be described, the present invention is not limited thereto, and may be applied to an optical pickup device that performs opposing light irradiation.

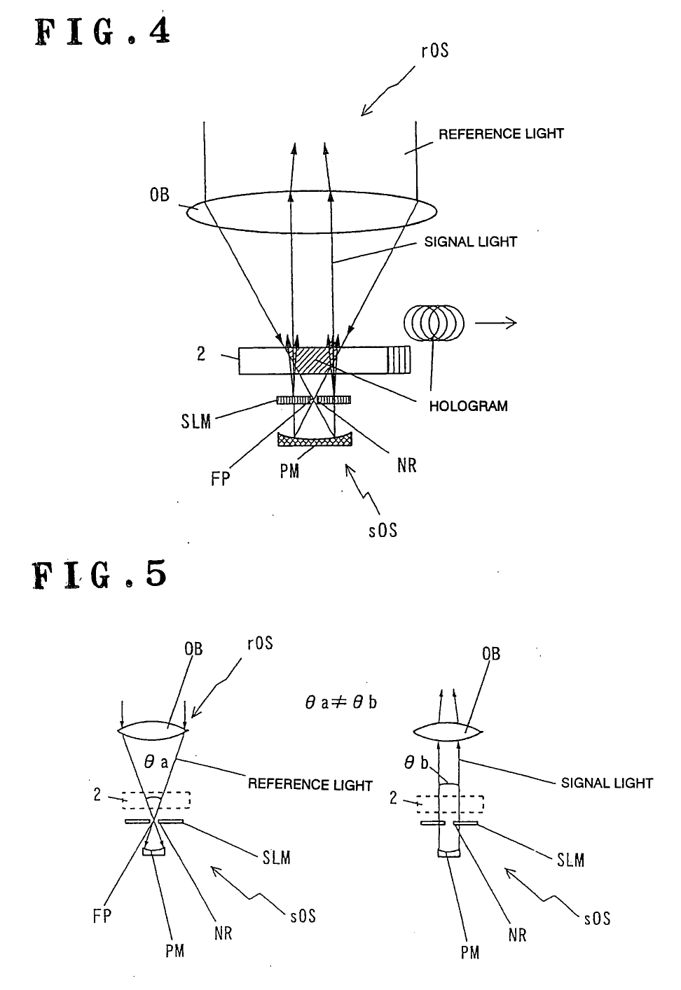

FIG. 4 shows an outline of the main parts of an optical system in a hologram device according to an embodiment.

In this hologram device, a reference light optical system rOS and a signal light optical system sOS are disposed on the same optical axis and at a remove from each other on either side of a hologram recording medium (recording medium) 2.

The reference light optical system rOS generates reference light and receives reproduction light, and includes an objective lens OB for condensing the reference light. As shown in FIG. 5, the objective lens OB condenses the reference light from within its effective diameter to a focal point FP at a first numerical aperture (sin θa).

The signal light optical system sOS includes a transmission spatial light modulator SLM. The spatial light modulator SLM is disposed at the focal point FP of the objective lens OB, for example. The spatial light modulator SLM has a light transmission portion NR in its center, including its optical axis, and is disposed such that the reference light converged in the light transmission portion NR passes through the light transmission portion NR unmodulated.

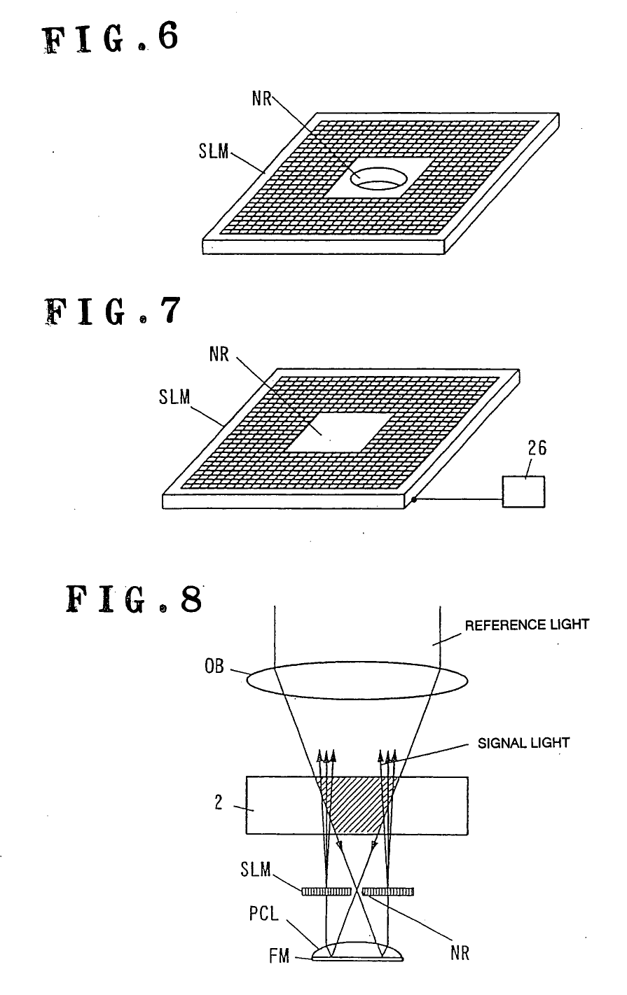

As shown in FIG. 6, the spatial light modulator SLM is constituted by a transmission matrix liquid crystal device, and the light transmission portion NR thereof, which is surrounded by a spatial light modulation region B, is constituted by a physically penetrating opening or a transparent material filling the opening. Alternatively, as shown in FIG. 7, the spatial light modulator SLM may be constituted in its entirety by a transparent matrix liquid crystal device such that the spatial light modulation region B for displaying a recording pattern and the non-modulating light transmission region of the light transmission portion NR on the inside thereof are displayed by a connected control circuit 26. In other words, the light transmission portion NR may be displayed as a translucent state of the spatial light modulator SLM during hologram recording.

In addition to the spatial light modulator SLM, the signal light optical system sOS includes a concave mirror, for example a parabolic mirror PM, on the opposite side to the entrance side for generating plane wave parallel light from the spherical wave reference light that diverges after passing through the recording medium 2 and the light transmission portion NR of the spatial light modulator SLM. The parabolic mirror PM is disposed coaxially with the objective lens OB such that the focal point thereof matches the focal point FP of the objective lens OB.

The signal light optical system sOS is disposed such that the parallel beams from the parabolic mirror PM pass through the spatial light modulator SLM and return to the objective lens OB of the reference light optical system rOS.

Hence, as shown in FIG. 5, in the optical system, the parabolic mirror PM and the spatial light modulator SLM generate signal light by spatially modulating the parallel beams in accordance with recording information, and pass the signal light through the recording medium 2 at a second numerical aperture (sin θb≠sin θa) (parallel light), which is different to the first numerical aperture of the objective lens OB, such that the signal light is transmitted in the opposite direction to the reference light.

The spatial light modulator SLM, which comprises the light transmission portion NR including the optical axis, functions to separate the reference light that passes through the light transmission portion NR from the signal light that is generated from the outside ring-shaped part of the spatial light modulator SLM on the periphery of the light transmission portion NR. The parabolic mirror PM functions to determine the effective diameter and numerical aperture of the luminous flux of the emitted signal light. In other words, a reflection portion such as the parabolic mirror PM sets the sectional area of the emitted luminous flux and the state of a parallel, convergent, or divergent wave front in a different state to that of the peripheral reference light. Thus, by means of the reflection portion on the rear of the spatial light modulator SLM, the signal light passes through the recording medium 2 toward the objective lens OB at the second numerical aperture, which is different to, for example smaller than, the first numerical aperture.

As shown in FIGS. 4 and 5, during recording, the reference light is emitted onto the recording medium 2 in a condensed state by the objective lens OB. After passing through the recording medium 2, the reference light is focused to its focal point, passes through the spatial light modulator SLM unmodulated, and then turns back into diffused light. The diffused light is then reflected by the reflection portion, such as the parabolic mirror PM, as parallel light. The parallel reflection light (reference light) passes through the spatial light modulator SLM on its way toward the recording medium 2 and is formed into signal light modulated in accordance with the recording information. The signal light is emitted onto the recording medium 2 in a plane wave and interferes with the oncoming spherical wave reference light in the recording medium 2 such that a hologram is recorded. The spatial light modulator SLM does not act on the oncoming reference light due to the light transmission portion NR in the vicinity of the focal point of the oncoming reference light.

During reproduction, the reflection portion on the rear surface side of the recording medium 2 is not required, and therefore, by providing non-reflecting means that halt the function of the reflection portion so that the reference light is not reflected, the reference light can be emitted from the front surface side of the recording medium 2, and reproduction light can be obtained on the same side without being obstructed by the reference light.

In a hologram device for recording or recording and reproduction, the non-reflecting means are provided in the signal light optical system sOS, while the reference light optical system rOS is provided with a photodetector for detecting the reproduction light that is generated from the recording medium 2 and optical means for guiding the reproduction light from the objective lens OB to the photodetector. In a reproduction-specific hologram device, the signal light optical system sOS is not required.

In an embodiment, the reference light has a spherical wave and the signal light has a plane wave. Hence, the intersection angle of the reference light and signal light can be secured to a certain extent, which is useful for shift multiplex recording. As shown in FIG. 4, multiplex recording can be performed by shifting the recording medium 2 in a perpendicular direction to the optical axis of the objective lens OB.

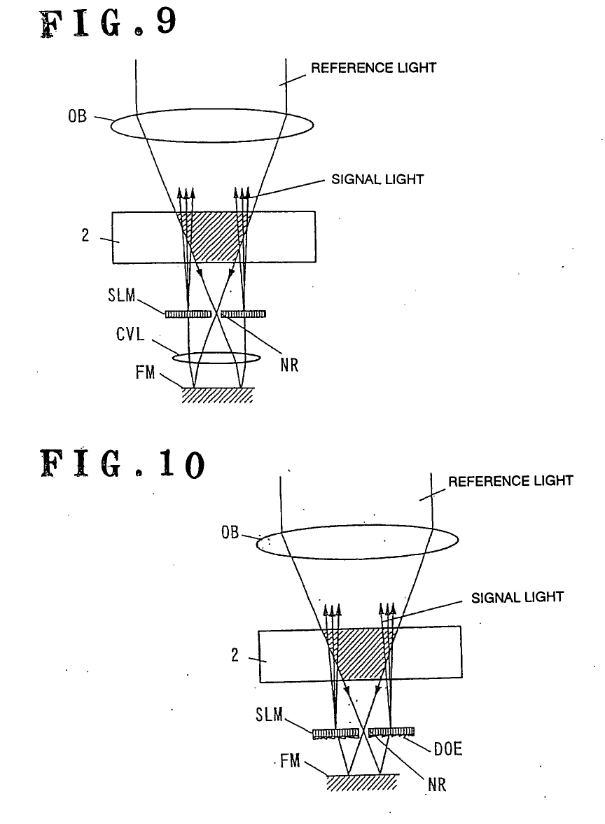

In the embodiment described above, a concave parabolic mirror is used as the reference light reflection portion, but in another embodiment, as shown in FIG. 8, an assembly constituted by a planoconvex lens PCL of the focal point FP and a planar mirror FM formed on a planar portion on the opposite side to the entrance side of the planoconvex lens PCL may be used as the reflection portion instead of a concave mirror. Further, as shown in FIG. 9, the reflection portion may be constituted by a combination of a convex lens CVL of the parallel separated focal point FP and a planar mirror. Furthermore, instead of the planoconvex lens PCL and the convex lens CVL, a diffraction optical element which acts as a convex lens for condensing light on the focal point FP may be used (not shown in the drawings). The diffraction optical element is an optical element such as a diffraction grating, which acts as a diffraction ring zone (a rotationally symmetrical body centering on the optical axis) constituted by a translucent flat plate and a plurality of phase steps, irregularities, or blazes formed thereon, or in other words as a convex lens. As shown in FIG. 10, when a diffraction optical element is used, a diffraction optical element DOE may be formed integrally with the spatial light modulator SLM on the periphery of the light transmission portion NR and combined with the parallel separated planar mirror FM to produce a simple constitution (in the drawing, the diffraction optical element DOE is positioned on the opposite side to the objective lens, but may be positioned on the same side as the objective lens).

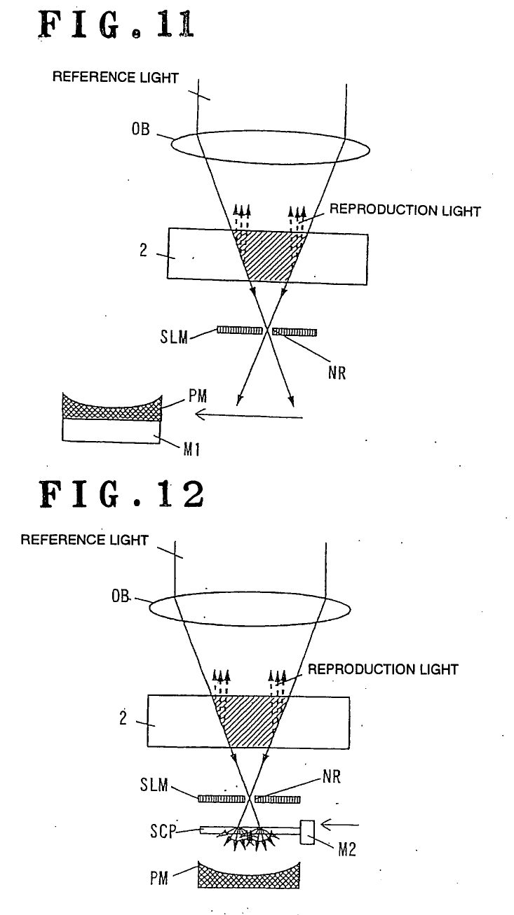

When reading the recorded recording medium 2 on a reproduction-specific device, a simple structure excluding the signal light optical system sOS of FIG. 4 suffices, and hence one of the merits of this system is the extreme simplicity of the recording-specific optical system. Further, when performing reproduction on a hologram device for recording or recording and reproduction, either a non-reflective mechanism M1 in which the parabolic mirror PM is removed from the optical axis, as shown in FIG. 11, or a non-reflective mechanism M2 in which a light-shielding plate or a scattering plate SCP is inserted, as shown in FIG. 12, may be provided during reproduction. Alternatively, as shown in FIG. 13, the reference light may be blocked by performing control using the connected control circuit 26 such that all of the pixels of the spatial light modulator SLM pattern become non-transmitting during reproduction, as a result of which the reference light does not return to the objective lens OB.

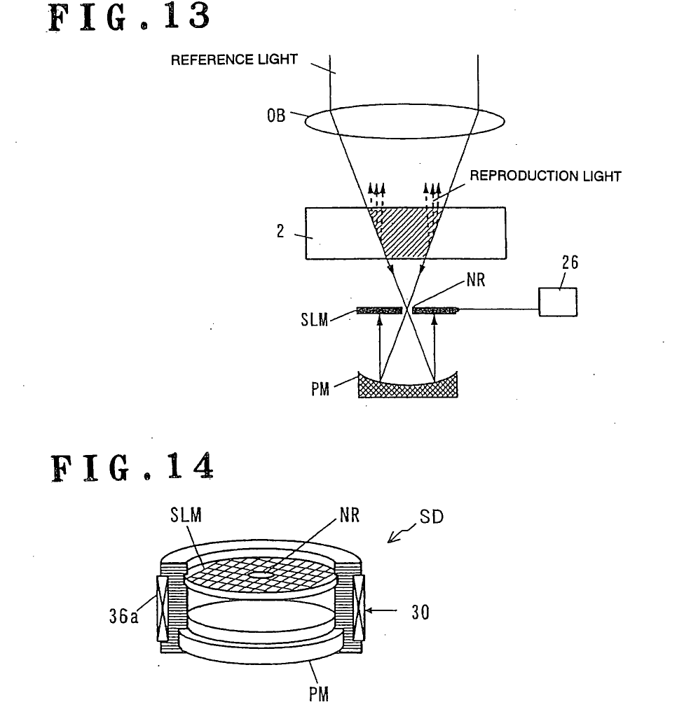

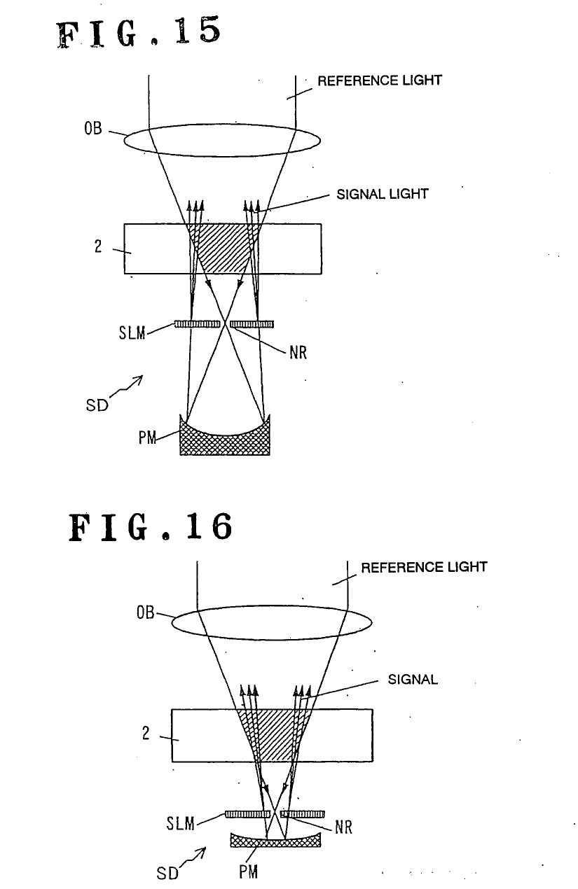

In an embodiment, when opposing irradiation is performed with convergent light (spherical wave) serving as the reference light and parallel light (plane wave) serving as the signal light, shift multiplex recording may be performed by moving the recording medium 2 in a horizontal direction perpendicular to the optical axis such that recording is performed in an overlapping fashion. As shown in FIG. 14, to align the optical axes of the reflection portion, such as the parabolic mirror PM, and the spatial light modulator SLM, the parabolic mirror PM and spatial light modulator SLM are fixed in alignment with the optical axis by a hollow holder such that a coil or the like wrapped around the parabolic mirror PM and spatial light modulator SLM can be provided as a reflection portion driving portion 36a, for example, and thus the parabolic mirror PM and spatial light modulator SLM are driven integrally. As a result, the spatial light modulator SLM disposed coaxially with the objective lens OB, the light transmission portion NR serving as a non-modulating region formed thereon, and the reflection portion, such as the parabolic mirror PM, for reflecting the reference light that passes through the spatial light modulator SLM function as a spatial light modulation device SD for generating signal light by modulating the reflected reference light. Making the spatial light modulation device SD freely movable within a pickup is advantageous during reproduction.

In the spatial light modulation device SD, the diameter of the light transmission portion NR, such as the penetrating opening of the spatial light modulator SLM, is set in consideration of parameters such as the diameter of the objective lens OB and the parabolic mirror PM, the gap therebetween, the numerical aperture thereof, and the focal length thereof, and also the bias thereof relative to the optical axis. Further, the outer diameter of the matrix liquid crystal device part on the periphery of the light transmission portion NR is set in consideration of similar parameters. The signal light is generated as parallel beams by the parabolic mirror PM on the rear of the spatial light modulator SLM, but these parallel beams may be directed toward the objective lens OB at the second numerical aperture, which is different to the first numerical aperture of the objective lens OB, and accordingly the specifications of the parabolic mirror PM may be set such that the reflected reference light converges within a certain range, as shown in FIG. 15, or diverges within a certain range, as shown in FIG. 16, for example. When spherical wave signal light converging as shown in FIG. 15 is used, the intersection angle of the spherical wave signal light and reference light, which propagate in opposing directions, approaches 90 degrees, thereby reducing angle selectivity and aiding shift multiplex recording.

### FIRST CONSTITUTIONAL EXAMPLE

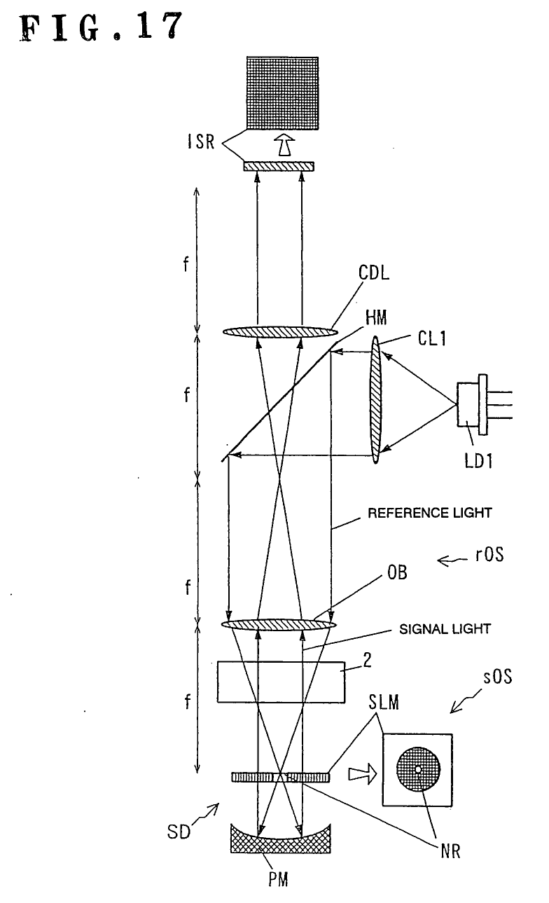

FIG. 17 shows a constitutional example of the main parts of a hologram device including a pair of optical systems, namely a reference light optical system rOS and a signal light optical system sOS, which are disposed on the same optical axis and at a remove from each other on either side of a recording medium 2.

An objective lens OB of the reference light optical system rOS and a spatial light modulator SLM of the signal light optical system sOS are disposed such that the distance (optical distance) therebetween is equal to a focal length f of the objective lens OB.

Further, in the reference light optical system rOS, a condenser lens CDL having a focal length f is disposed in a position at an optical distance f from the objective lens OB, and an image sensor ISR is disposed in a position at an optical distance f from the condenser lens CDL. A half mirror HM is disposed between the objective lens OB and the condenser lens CDL such that reference light emitted from a recording/reproduction laser LD1 is formed into parallel light by a collimator lens CL1, reflected by the half mirror HM, and directed toward the recording medium 2 via the objective lens OB.

The reference light condensed by the objective lens OB passes through the recording medium 2, and then passes unmodulated through a hole (a light transmission portion NR) in a central portion of the spatial light modulator SLM near the focal plane.

After passing through the hole in the spatial light modulator SLM, the reference light is reflected by a parabolic mirror PM to form parallel light, and by passing through the spatial light modulator SLM, the parallel light receives spatial modulation to form signal light. At this time, an information pattern to be recorded is displayed on the spatial light modulator SLM as a monochrome light-dark pattern. The signal light enters the recording medium 2 and interferes with the oncoming reference light to form a hologram in the recording medium 2.

In this example, during recording, the display pattern on the spatial light modulator SLM forms an image as is on the image sensor ISR. Likewise during hologram recording in the recording medium 2, the signal light that has passed through the recording medium 2 is formed into an image on the image sensor ISR by the objective lens OB and the condenser lens CDL, and therefore a mixed image comprising the image of the pattern on the spatial light modulator SLM and a reproduced image of the hologram that has just been recorded is formed on the image sensor ISR. The image formed on the image sensor ISR is of no particular use at this time.

During reproduction, the reference light is blocked so that it does not impinge on the recording medium 2, and therefore only the light that is reproduced from the hologram is reproduced from the recording medium 2.

FIG. 18 is a schematic diagram of this hologram device.

In a hologram device 1, the reference light optical system rOS and the signal light optical system sOS are fixed independently on either side of the recording medium 2, and a support portion SS for holding the medium 2 detachably is provided so that the recording medium 2 is disposed between the focal point FP and the objective lens OB. By making the support portion SS movable in the XYZ directions, which are perpendicular to each other, a reference light objective lens rO and a signal light objective lens sO are fixed into position, and therefore, when the recording medium 2 takes the form of an optical card, for example, it can be positioned easily, rendering high precision positioning of a focus servo, a tracking servo, and so on unnecessary.

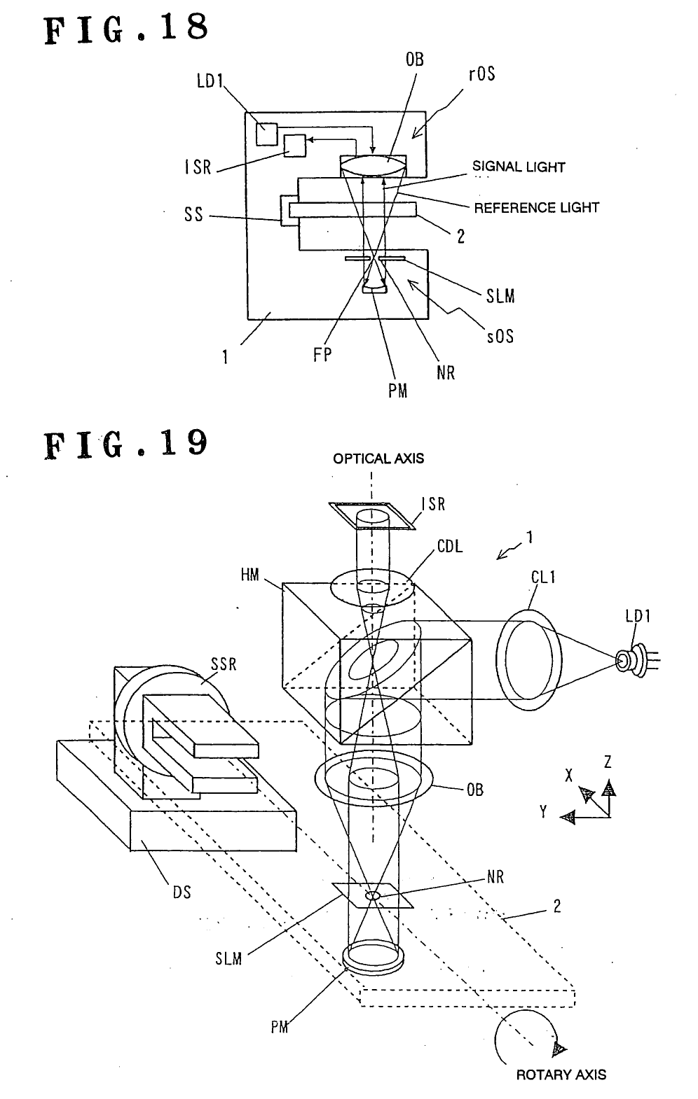

In another embodiment, shift multiplex recording can be performed, and a multi-angle method may be employed as the multiplex recording method. As shown in FIG. 19, a recording device is constituted such that the recording medium 2 is mounted on a rotary support portion SSR having a perpendicular rotary axis to the optical axis of the recording medium 2, whereby the recording medium 2 is held in a manner allowing rotary driving thereof. Further, a driving stage DS for making the support portion SSR capable of translational movement in the XYZ directions, which are perpendicular to the optical axis of the optical system and perpendicular to each other, is provided. In a hologram recording and reproduction device comprising the rotary support portion SSR and the driving stage DS, the medium 2 is rotated about a perpendicular axis to the optical axis, and thus multi-angle hologram recording can be performed.

### OTHER EMBODIMENTS

In the optical system of the embodiment shown in FIG. 4, a constitution in which converged reference light is supplied from the reference light optical system rOS to the signal light optical system sOS, which are disposed on the same optical axis and at a remove from each other on either side of the recording medium 2, was described, but in an embodiment shown in FIG. 20, parallel (plane wave) reference light can be supplied from the reference light optical system rOS to the signal light optical system sOS.

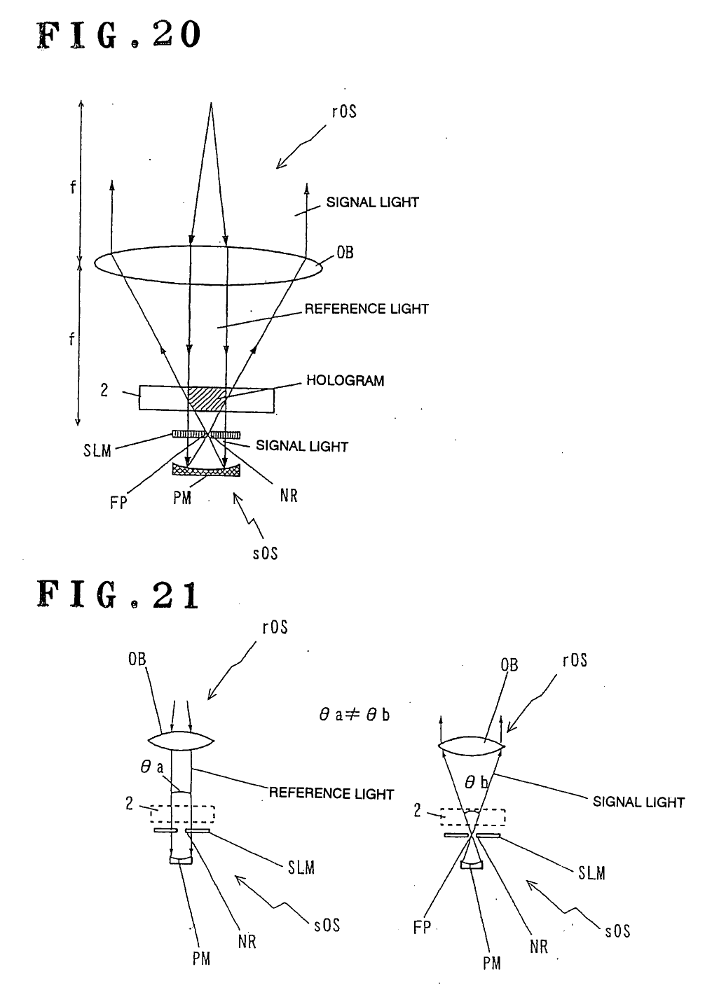

The reference light optical system rOS includes an objective lens OB, which turns divergent light (reference light) into substantially parallel light. As shown in FIG. 21, the objective lens OB emits the reference light toward the recording medium 2 and the signal light optical system sOS at a first numerical aperture (sin θa) (in parallel light, θa=0) corresponding to the effective diameter thereof.

In the signal light optical system sOS, a transmission spatial light modulator SLM disposed at a focal point FP of the objective lens OB is identical to that of the embodiment described above, and therefore comprises a light transmission portion NR in the center thereof, including the optical axis thereof, through which signal light converged into the light transmission portion NR by a parabolic mirror PM passes unmodulated. Having passed through the recording medium 2, the parallel light is modulated by the spatial light modulator SLM.

In other words, similarly to the embodiment described above, the parabolic mirror PM is disposed coaxially with and on the opposite side to the entrance side of the spatial light modulator SLM such that the focal point thereof matches the focal point FP of the objective lens OB. The parabolic mirror PM reflects the plane wave signal light that passes through the recording medium 2 and spatial light modulator SLM as spherical wave convergent beams.

The signal light optical system sOS is disposed such that the convergent beams from the parabolic mirror PM pass through the light transmission portion NR of the spatial light modulator SLM and return to the recording medium 2 and the objective lens OB of the reference light optical system rOS as divergent signal light.

Hence, in this optical system, as shown in FIG. 21, the parabolic mirror PM and the spatial light modulator SLM generate signal light by subjecting the parallel reference light to spatial modulation in accordance with recording information, and pass the signal light through the recording medium 2 at a second numerical aperture (sin θb≠sin θa), which is different to the first numerical aperture of the objective lens OB, such that the signal light is transmitted in the opposite direction to the reference light. Hence, by means of a reflection portion on the rear of the spatial light modulator SLM, the signal light passes through the recording medium 2 on its way to the objective lens OB at the second numerical aperture, which is different to, for example greater than, the first numerical aperture.

As shown in FIGS. 20 and 21, during recording, the reference light is emitted onto the recording medium 2 by the objective lens OB as parallel light. Having passed through the recording medium 2, the reference light passes through the spatial light modulator SLM unmodulated, and forms signal light that is modulated in accordance with the recording information. The parallel signal light is reflected as convergent light by the parabolic mirror PM, forms a focal point in the light transmission portion NR of the spatial light modulator SLM, and then becomes divergent light. Having become divergent, the signal light passes through the recording medium 2 and interferes with the oncoming plane wave reference light in the recording medium 2 such that a hologram is recorded. The light transmission portion NR of the spatial light modulator SLM does not act on the signal light.

By providing non-reflecting means that halt the function of the reflection portion, such as the parabolic mirror PM, so that the reference light is not reflected during reproduction, the plane wave reference light can be emitted from the front surface side of the recording medium 2, and spherical wave reproduction light can be obtained on the same side without being obstructed by the reference light.

In this embodiment, the reference light has a plane wave and the signal light has a spherical wave, and therefore the intersection angle of the reference light and signal light can be secured to a certain extent, which is useful for shift multiplex recording.

### SECOND CONSTITUTIONAL EXAMPLE

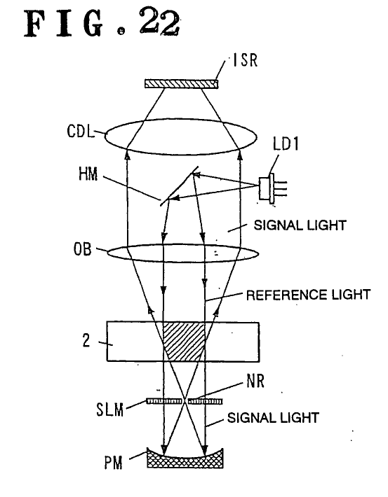

FIG. 22 shows a constitutional example of a hologram device including a pair of optical systems, namely a reference light optical system rOS and a signal light optical system sOS, which are disposed on the same optical axis and at a remove from each other on either side of a recording medium 2.

An objective lens OB of the reference light optical system rOS and a spatial light modulator SLM of the signal light optical system sOS are disposed at a distance that is equal to the focal length of the objective lens OB.

Further, in the reference light optical system rOS, a condenser lens CDL is disposed on the opposite side of the recording medium 2 coaxially with the objective lens OB, and an image sensor ISR is disposed in the image forming position of the condenser lens CDL. A half mirror HM is disposed between the objective lens OB and condenser lens CDL such that reference light emitted from a recording/reproduction laser LD1 (in the focal point position when the objective lens OB is used as a collimator, but laser divergent light that is formed into parallel light by the objective lens OB may be generated by another optical system) is reflected by the half mirror HM and directed toward the recording medium 2 via the objective lens OB as parallel light.

The reference light is turned into parallel light by the objective lens OB. The parallel light passes through the recording medium 2 and then passes through the spatial light modulator SLM, where it is subjected to spatial modulation to form signal light. At this time, an information pattern to be recorded is displayed on the spatial light modulator SLM as a monochrome light-dark pattern. The parallel signal light is reflected by a parabolic mirror PM to form convergent light, and passes unmodulated through a hole (a light transmission portion NR) in a central portion of the spatial light modulator SLM near the focal plane.

After passing through the hole in the spatial light modulator SLM, the diffused signal light enters the recording medium 2 and interferes with the oncoming parallel reference light to form a hologram in the recording medium 2.

During reproduction, the reference light is blocked so that it does not impinge on the recording medium 2, and therefore only the light that is reproduced from the hologram is reproduced from the recording medium 2.

This embodiment employs a spatial light modulation device SD and plane wave reference light, and may therefore employ a conventional pickup. Hence, the constitution thereof is extremely simple, which is one advantage of this system.

[Hologram Device for Disk-Form Recording Medium]

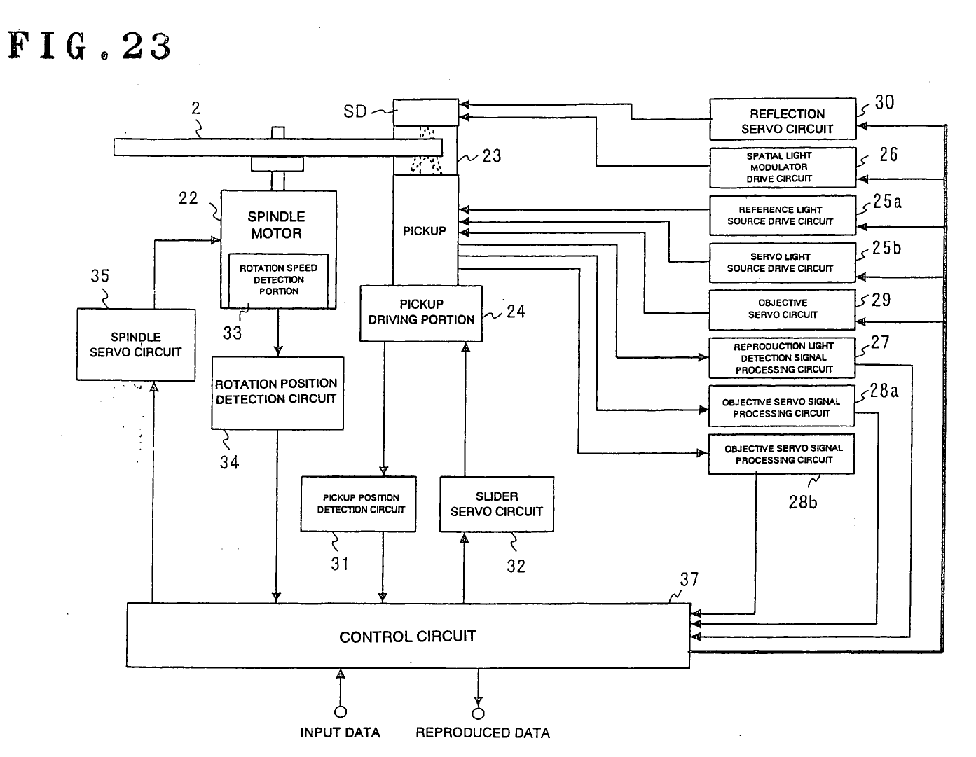

FIG. 23 shows an example of the schematic constitution of a hologram device for recording or reproducing information on/from a disk-form hologram recording medium (disk) 2, to which the present invention is applied.

The hologram device comprises a spindle motor 22 for rotating the disk 2 via a turntable, a pickup 23 (which is formed integrally with a spatial light modulation device SD, but may be formed separately) for reading a signal from the recording medium 2 using a light beam, a pickup driving portion 24 for supporting the pickup and moving the pickup in a radial direction (x direction), a reference light source drive circuit 25a, a servo light source drive circuit 25b, a spatial light modulator drive circuit 26, a reproduction light signal detection circuit 27, an objective servo signal processing circuit 28a, a reflection servo signal processing circuit 28b, an objective servo circuit 29, a reflection servo circuit 30, a pickup position detection circuit 31 which is connected to the pickup driving portion 24 and detects a position signal from the pickup, a slider servo circuit 32 which is connected to the pickup driving portion 24 and supplies a predetermined signal thereto, a rotation speed detection portion 33 which is connected to the spindle motor 22 and detects a rotation speed signal from the spindle motor, a rotation position detection circuit 34 which is connected to the rotation speed detection portion and generates a rotation position signal relating to the disk 2, and a spindle servo circuit 35 which is connected to the spindle motor 22 and supplies a predetermined signal thereto.

The hologram device also comprises a control circuit 37, and the control circuit 37 is connected to the reference light source drive circuit 25a, servo light source drive circuit 25b, spatial light modulator drive circuit 26, reproduction light signal detection circuit 27, objective servo signal processing circuit 28a, objective servo circuit 29, reflection servo circuit 30, pickup position detection circuit 31, slider servo circuit 32, rotation speed detection portion 33, rotation position detection circuit 34, and spindle servo circuit 35. On the basis of signals from the detection circuits, the control circuit 37 performs x (track perpendicular), y (track parallel), and z (focus) direction movement servo control, reproduction position (x direction and y direction position) control, and so on in relation to the pickup via the drive circuits. The control circuit 37 is constituted by a microcomputer installed with various types of memory, and performs control of the entire device. The control circuit 37 generates various control signals in accordance with operation input performed by a user on an operating portion (not shown) and the current device operating condition, and is connected to a display portion (not shown) for displaying the operating condition and so on to the user.

Further, the control circuit 37 executes processing such as encoding of data input from the outside to be subjected to hologram recording, and controls the hologram recording sequence by supplying the spatial light modulator drive circuit 26 with a predetermined signal. The control circuit 37 restores the data recorded on the disk 2 by performing demodulation and error correction processing on the basis of a signal from the reproduction light signal detection circuit 27. Further, by implementing decoding processing on the restored data, the control circuit 37 performs information data reproduction and outputs the data as reproduced information data.

The control circuit 37 also generates a slider drive signal on the basis of a position signal from the operating portion or the pickup position detection circuit 31 and an x direction movement error signal from the objective servo signal processing circuit 28a, and supplies this signal to the slider servo circuit 32. The slider servo circuit 32 moves the pickup 23 in the disk radius direction via the pickup driving portion 24 and in accordance with a drive current corresponding to the slider drive signal.

The rotation speed detection portion 33 detects a frequency signal indicating the current rotational frequency of the spindle motor 22, which rotates the disk 2 using the turntable, generates a corresponding rotation speed signal indicating the spindle rotation speed, and supplies this signal to the rotation position detection circuit 34. The rotation position detection circuit 34 generates a rotation speed position signal and supplies this signal to the control circuit 37. The control circuit 37 generates a spindle drive signal, supplies this signal to the spindle servo circuit 35, and controls the spindle motor 22 to drive the disk 2 to rotate.

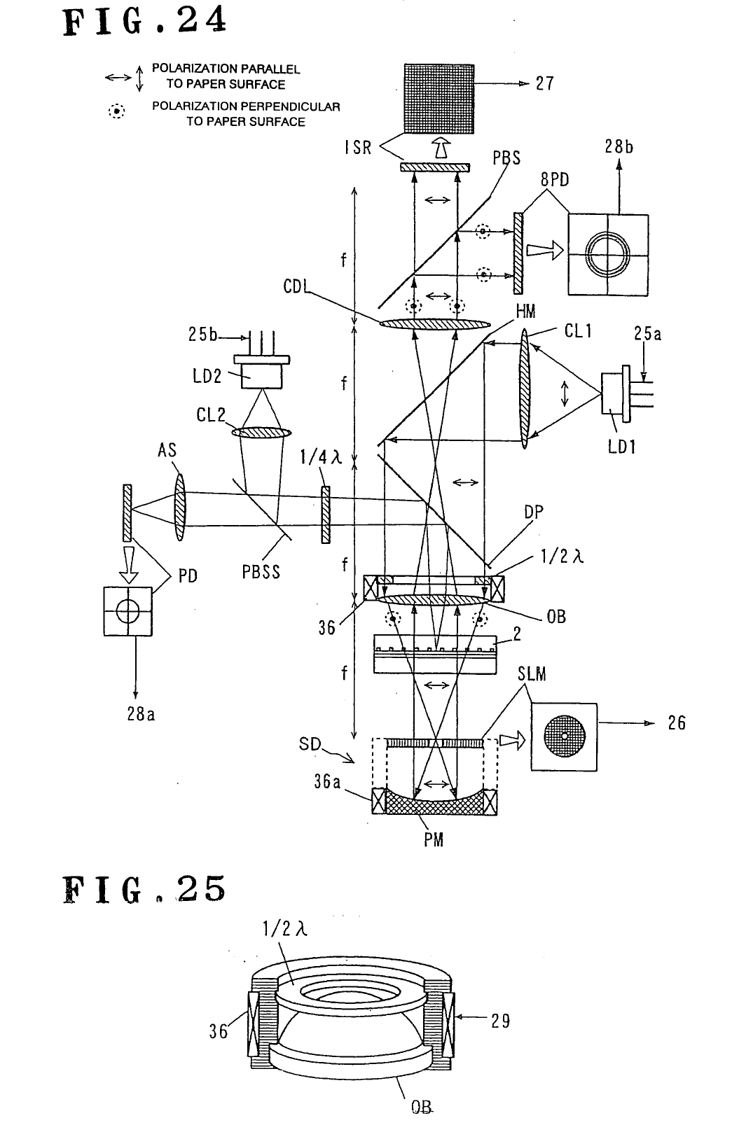

FIG. 24 shows the schematic constitution of the pickup of this hologram device.

The pickup 23 comprises a reference light optical system serving as an irradiation optical system, and the spatial light modulation device SD, which serves as a signal light optical system disposed on the optical axis at a remove from and opposite the reference light optical system and includes a reflection portion for reflecting and returning reference light toward the irradiation optical system. The disk 2 is disposed between the irradiation optical system and the spatial light modulation device SD.

The irradiation optical system is constituted by a reference light recording and reproduction laser LD1, a collimator lens CL1, a half mirror HM, an objective lens OB for condensing the reference light toward the spatial light modulation device SD at a first numerical aperture, a condenser lens CDL, and an image sensor ISR constituted by a CCD (charge coupled device) array, a CMOS (complementary metal oxide semiconductor) array, or another array. The objective lens OB and spatial light modulation device SD are provided drivably in a casing of the pickup 23.

The recording and reproduction laser LD1 is connected to the reference light source drive circuit 25a, and the output thereof is adjusted by the circuit such that the intensity of the emitted reference light is high during hologram recording and low during reproduction. An objective servo photodetector PD is connected to the servo light source drive circuit 25b.

The image sensor ISR is connected to the reproduction light signal detection circuit 27.

The spatial light modulation device SD includes a spatial light modulator SLM disposed coaxially with the objective lens OB and formed with a light transmission portion NR serving as a non-modulating region, and a reflection portion such as a parabolic mirror PM for reflecting the reference light that passes through the spatial light modulator SLM. As shown in FIG. 14, the parabolic mirror PM and spatial light modulator SLM are fixed in alignment with the optical axis by a hollow holder, and the reflection portion driving portion 36a, which takes the form of a coil or the like, is wrapped around the hollow holder. The spatial light modulator SLM functions to block a part of the light that is incident thereon electrically by means of a liquid crystal panel or the like having a plurality of transparent pixel electrodes divided into matrix form, or a function for transmitting all of the incident light such that no light is reflected. The spatial light modulator SLM is connected to the spatial light modulator drive circuit 26, and generates signal light by subjecting a light beam to spatial modulation such that the light beam has a distribution based on supplied page data (a two-dimensional data information pattern such as a planar light-dark dot pattern) to be recorded. The spatial light modulation device SD receives the reference light at the first numerical aperture, generates signal light, and causes the signal light to pass through the disk 2 at a second numerical aperture which is different to the first numerical aperture.

The irradiation optical system is provided with an objective servo system for performing position control on the objective lens OB, and a reflection servo system for performing position control on the spatial light modulation device SD.

[Objective Servo System]

The objective servo system comprises a servo laser LD2, a convex lens CL2, a polarization beam splitter PBSS, a ¼ wavelength plate ¼λ, a dichroic prism DP, a detection lens AS, an objective servo signal detection portion including the objective servo photodetector PD, and an objective lens driving portion 36 for moving the objective lens OB in a direction parallel to the optical axis of the objective lens OB (the z direction), a parallel direction to the track (y direction), and a perpendicular direction to the track (x direction) on the basis of a photoelectric conversion output from the objective servo photodetector PD for servo-controlling the position of a light beam relative to the disk 2.

The objective servo photodetector PD is connected to an objective lens servo portion of the objective servo signal processing circuit 28a, and comprises light-receiving elements for a focus servo and an x and y direction movement servo, for example. Output signals from the objective servo photodetector PD are supplied to the objective servo signal processing circuit 28a.

The objective servo signal processing circuit 28a generates a drive signal on the basis of an error signal obtained through calculation on the basis of the output of the objective servo photodetector PD, and supplies this signal to the control circuit 37. The control circuit 37 supplies the drive signal to the objective servo circuit 29, and the objective servo circuit 29 drives a three-axis actuator (the objective lens driving portion 36) in accordance with the drive signal. Thus, during both hologram recording and reproduction, the disk 2 is positioned on three axes, i.e. the x, y, and z directions, by a servo beam.

For example, z direction servo (focus servo) control may employ an astigmatism method, a spot size method, or another method used in a typical pickup, or a method that uses these methods in combination. For example, when an astigmatism method is used, a four-split photodetector and an astigmatism optical element are employed. A light reception portion of the four-split photodetector is constituted by four independent light-receiving elements that are disposed near each other, with two orthogonal dividing lines serving as boundary lines, and receive beam components passing through a ring zone about the intersection between the dividing lines. The astigmatism optical element is a cylindrical lens, an oblique incidence transparent flat plate, or similar, for example. In this case, the servo signal processing circuit generates the difference between the output sum of two diagonally opposing light-receiving elements of the four light-receiving elements and the output sum of the other light-receiving elements as a focus error signal relating to distance.

[Reflection Servo System]

The reflection servo system comprises a ½ wavelength plate ½λ, a reflection servo photodetector 8PD, the polarization beam splitter PBS, and the reflection portion driving portion 36a of the spatial light modulation device SD. Note that in FIG. 24, the aforesaid optical components are disposed substantially congruently, but the present invention is not limited thereto.

The ½ wavelength plate ½λ is a phase plate having a ring zone, and is fixed to the objective lens OB to apply an annular phase difference to the effective diameter of the reference light passing therethrough and beam components passing through regions in the vicinity thereof. As shown in FIG. 25, the ½ wavelength plate ½λ and objective lens OB are fixed in alignment with the optical axis by a hollow holder, and the objective lens driving portion 36, which takes the form of a coil or the like, is wrapped around the hollow holder.

The polarization beam splitter PBS is disposed on the optical axis of the irradiation optical system, extracts a beam component passing through the ring zone from return light, and guides this component to the reflection servo photodetector 8PD.

A light reception portion of the reflection servo photodetector 8PD is constituted by four independent central light-receiving elements that are disposed near each other, with two orthogonal dividing lines (in the x and y directions) serving as boundary lines, and receive a beam component passing through a ring zone centered on the intersection between the dividing lines, and four outside light-receiving elements disposed near each other on the respective outer sides of the four central light-receiving elements.

The reflection servo signal processing circuit 28b connected to the reflection servo photodetector 8PD generates the difference between the output sum of the four central light-receiving elements and the output sum of the four outside light-receiving elements as an error signal of the distance between the objective lens OB and the reflection portion, and at the same time generates the difference between the output sum of two of the four central light-receiving elements and two of the four outside light-receiving elements on one side of one of the two dividing lines and the output sum of the other light-receiving elements as a bias error signal of the reflection portion from the optical axis, and supplies these signals to the control circuit 37. The control circuit 37 moves the reflection portion driving portion 36a of the spatial light modulation device SD in the xy and z directions via the objective servo circuit 29 and in accordance with xy and z direction movement drive signals. In other words, the reflection portion driving portion 36a of the spatial light modulation device SD moves the spatial light modulation device SD in the xy and z directions on the basis of photoelectric conversion output from the reflection servo photodetector 8PD. Accordingly, the spatial light modulation device SD is driven by an amount corresponding to a drive current produced by the xy and z direction drive signals. Thus, a hologram formation period can be secured while maintaining the spatial light modulation device SD in a fixed position relative to the objective lens OB.

Thus, position control (interval and optical axis bias correction) of the spatial light modulation device SD relative to the objective lens OB is performed by the reflection portion driving portion 36a using a part of the signal light.

[Reflection Portion Driving Portion]

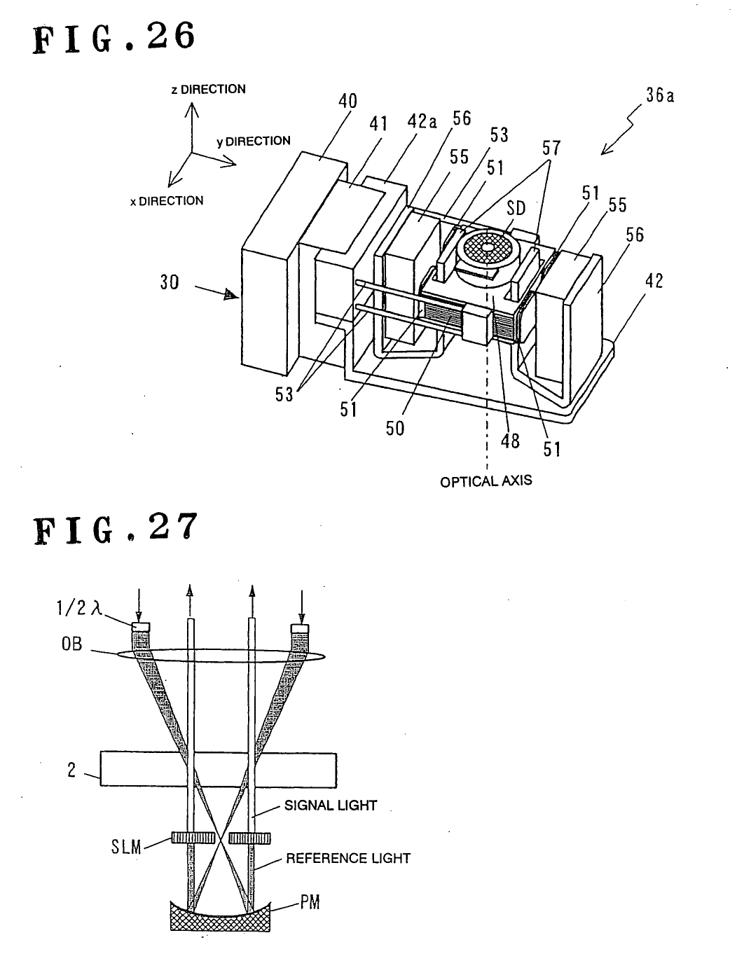

FIG. 26 shows the reflection portion driving portion 36a of the reflection portion used in the hologram device of this embodiment.

The reflection portion driving portion 36a has an actuator base 42 that can vibrate freely in the y direction by means of a piezo element 41 that is coupled to a support portion 40 fixed to a reflection portion body (not shown).

The spatial light modulation device SD, including the parabolic mirror PM and the spatial light modulator SLM, is attached to the interior of a holder 48. A z direction coil 50 is wrapped around the outer periphery of the holder 48 such that the central axis of the coil is parallel to the optical axis of the parabolic mirror PM. Four x direction coils 51, for example, are attached to the outside of the z direction coil 50 such that the central axes of the coils are at right angles to the optical axis of the parabolic mirror PM. Each x direction coil 51 is formed by adhering individual components wound into a ring shape in advance onto the z direction coil 50. The holder 48 is supported by one end portion of four lengthwise support members 53. Note, however, that in the drawing, only three of the support members 53 are shown. The four lengthwise support members 53 are disposed at a remove from each other in the optical axis direction of the parabolic mirror PM, and are constituted by two pairs extending in the y direction at a right angle to the optical axis direction of the parabolic mirror PM. Each support member 53 is attached in cantilever form by the other end portion thereof to a protruding portion 42a that is fixed onto the actuator base 42. Each support member 53 is formed from a coil material or the like and possesses flexibility. By means of the four lengthwise support members 53 and the aforesaid piezo element 41, the spatial light modulation device SD including the parabolic mirror PM can move freely in the xy and z directions.

The holder 48 is sandwiched between a pair of magnetic circuits, which are provided at a remove from the holder 48. Each magnetic circuit is constituted by a magnet 55 facing the holder 48 and a metal plate 56 supporting the magnet 55, and is fixed onto the actuator base 42. A pair of through holes is formed in the flank of the holder 48, and the pair of through holes are positioned on either side of the parabolic mirror PM in parallel with the coil central axis and the optical axis of the parabolic mirror PM on the inside of the z direction coil 50 of the holder 48 in the extension direction of the lengthwise support members 53. A yoke 57 extending from the metal plate 56 of the magnetic circuit is inserted into each through hole in a state of non-contact. Thus, the z direction coil 50 and the x direction coils 51 are positioned within a magnetic gap of a magnetic circuit constituted by the magnet 55 and the yokes 57.

The z direction coil 50, x direction coils 51, and piezo element 41 are respectively controlled by the reflection servo circuit 30 for supplying z, x, and y direction drive signals. Parallel magnetic flux linked to each coil at a right angle can be generated in the magnetic gap, and therefore, by supplying each coil with a predetermined current, x and z direction drive force is generated, whereby the aforesaid movable optical system can be driven in each of these directions.

Thus, a voice coil motor is used to drive the parabolic mirror PM in the x and y directions, whereas the piezo element and so on are used for y direction driving, whereby the whole actuator base is driven. Note that a voice coil motor may be used for all axes of the driving portion, rather than the structure described above.

[Operation of Hologram Device]

As shown in FIG. 24, reference light emitted from the recording and reproduction laser LD1 having a wavelength λ1 is linearly polarized light having a parallel polarization to the paper surface. The reference light is turned into parallel light by the collimator lens CL1, reflected by the half mirror HM, and directed toward the objective lens OB and the disk 2. The dichroic prism DP is constituted to transmit λ1 reference light and reflect light from the servo laser LD2 having a wavelength of λ2, and therefore the reference light passes through the dichroic prism DP as is.

The ring-shaped ½ wavelength plate ½λ is disposed immediately before the objective lens OB, and therefore the outer peripheral light alone of the reference light is turned into linearly polarized light having a perpendicular polarization direction to the paper surface. The reference light is condensed by the objective lens OB, passes through the disk 2, and since a hole (a light transmission portion NR) is opened in the central portion of the spatial light modulator SLM near the focal plane, the reference light passes therethrough without receiving any actions. The diameter of the hole may be increased to a certain extent in consideration of the diameter of the objective lens OB and parabolic mirror PM and bias thereof relative to the optical axis.

After passing through the hole in the spatial light modulator SLM, the reference light is reflected by the parabolic mirror PM to form parallel light, and by passing through the spatial light modulator SLM on the periphery of the light transmission portion NR, the parallel light is spatially modulated to become signal light. At this time, an information pattern to be recorded is displayed on the spatial light modulator SLM as a monochrome light-dark pattern. The signal light enters the disk 2 and interferes with the oncoming reference light to form a hologram in a recording layer of the disk 2.

The distance (optical distance) between the objective lens OB and the spatial light modulator SLM is set to be equal to a focal length f of the objective lens OB. Further, the condenser lens CDL, which has a focal length f, is disposed in a position at an optical distance f from the objective lens OB in the opposite direction to the disk 2, and the image sensor ISR and reflection servo photodetector 8PD are disposed in a position at an optical distance f from the condenser lens CDL. The polarization beam splitter PBS is disposed between the condenser lens CDL and the image sensor ISR, and is constituted to transmit P polarized light and reflect S polarized light relative to a 45° splitting face. The polarization direction of the reference light is parallel to the paper surface, and therefore the reference light becomes P polarized light relative to this surface. Hence, the reference light is transmitted toward the image sensor ISR. Note, however, that the light component that passes through the ½ wavelength plate ½λ becomes S polarized light, and therefore this component is reflected toward the reflection servo photodetector 8PD. With this structure, the display pattern on the spatial light modulator SLM produces an image on the image sensor ISR as is. Likewise during hologram recording in the disk 2, the signal light that has passed through the disk 2 is formed into an image on the image sensor ISR by the objective lens OB and the condenser lens CDL, and therefore a mixed image comprising the image of the pattern on the spatial light modulator SLM and a reproduced image of the hologram that has just been recorded is formed on the image sensor ISR.

The outer peripheral light on which the ½ wavelength plate ½λ acts and the inner peripheral light on which the ½ wavelength plate ½λ does not act become linearly polarized light having polarization directions that differ by 90°, and therefore do not interfere with each other. The holograms that may be recorded on the disk 2 are an interference pattern produced by the inner peripheral reference light beams that pass through the inside of the annulus and an interference pattern produced by the outer peripheral reference light beams that pass through the annular part. Note that by adjusting the position of the disk 2 such that the beam radius of the signal light is sufficiently smaller than the beam radius of the reference light within the disk 2, it is possible to prevent recording of the interference pattern produced by the outer peripheral reference light beams. As shown in FIG. 27, for example, a hologram is recorded in annular form in the disk 2 in the position where the outer peripheral reference light beams overlap, but by changing the position of the disk 2 toward the objective lens OB, as shown in FIG. 28, the reference light beams do not overlap within the disk 2, and a hologram is not recorded. Typically, the former case is employed, but when the latter case is employed, the hologram of the interference pattern produced by the inner peripheral reference light beams is surrounded by an annular unrecorded blank that serves as a target during reproduction.

During reproduction, the reference light is blocked by the non-reflecting means so that it does not impinge on the disk 2, and therefore only the light that is reproduced from the hologram is reproduced from the disk 2. The interference pattern produced by the inner peripheral reference light beams is reproduced by the light on the inside of the ½ wavelength plate ½λ, passes through the polarization beam splitter PBS, and a reproduction signal thereof forms an image on the image sensor ISR. The interference pattern produced by the outer peripheral reference light beams is reproduced by the light that passes through the ½ wavelength plate ½λ, reflected by the polarization beam splitter PBS, and forms an image on the reflection servo photodetector 8PD. The reproduction light is substantially parallel light, and therefore passes through the center of the annular ½ wavelength plate ½λ such that the ½ wavelength plate ½λ does not act thereon. Hence, the light beam is preferably returned on the inside of the ring zone of the ½ wavelength plate ½λ.

The servo laser LD2, which has a different wavelength to the recording and reproduction laser LD1, serves to generate a servo signal for driving the objective lens OB such that the objective lens OB and the disk 2 are disposed in predetermined relative positions. Needless to say, the focal point position of the servo beam and the focal point position of the recording and reproduction laser LD1 are adjusted such that a predetermined gap is formed therebetween. The light emitted from the servo laser LD2 is linearly polarized light that is formed into slightly convergent light by the convex lens CL2 and emitted onto the polarization beam splitter PBSS. This servo beam forms S polarized light relative to the splitting surface of the polarization beam splitter PBSS and is therefore reflected so as to pass through a ¼ wavelength plate ¼λ and form circularly polarized light that enters the dichroic prism DP. Since the wavelength of the servo beam is λ2, the servo beam is reflected by the dichroic prism DP in the direction of the disk 2. The beam diameter of the servo beam is small enough to pass through the inner diameter of the ½ wavelength plate ½λ, and therefore the servo beam enters the objective lens OB without receiving the action of the ½ wavelength plate ½λ. The objective lens OB condenses the servo beam into the disk 2.

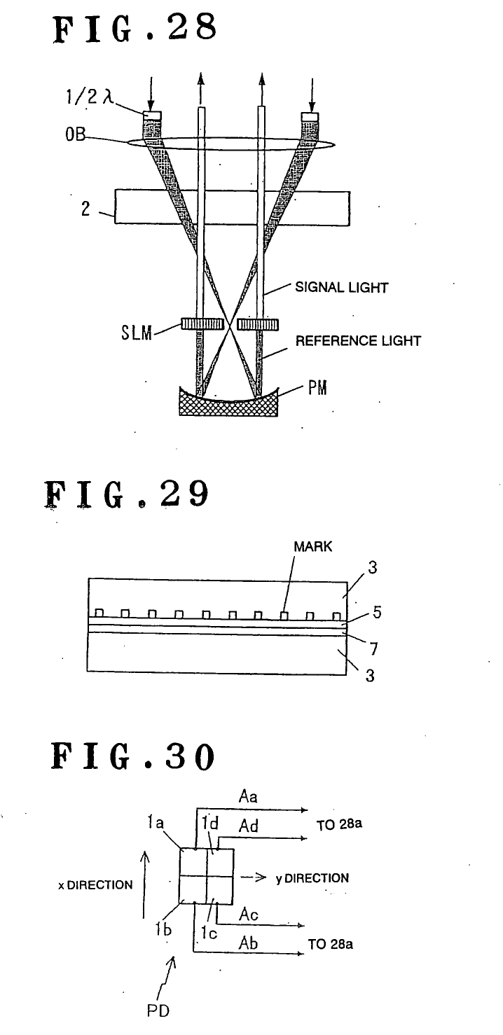

The disk 2 has a sectional structure such as that shown in FIG. 29, for example, comprising a wavelength selective reflection layer 5 and a hologram recording layer 7 sandwiched between a pair of substrates 3. A photorefractive material, a hole burning material, a photochromic material, or a similar material is used as the photosensitive material forming the hologram recording layer 7 for holding an optical interference pattern. A metallic film, a phase-change film, a dye film, or a combination thereof, for example, is used for the wavelength selective reflection layer 5 on the light irradiation side, and the wavelength selective reflection layer 5 is set to transmit the reference light wavelength and reflect only the servo beam wavelength. The substrate 3 is made of glass, a plastic such as polycarbonate, amorphous polyolefin, polyimide, PET, PEN, or PES, ultraviolet curing acrylic resin, or another material, for example. A mark such as a track or a pit for tracking the servo beam is provided on the main surface of the wavelength selective reflection layer 5.

The servo beam condensed by the objective lens OB is reflected by the wavelength selective reflection layer 5 (recording medium 2), and returns along the same path. The servo beam then passes through the ¼ wavelength plate ¼λ again to form linearly polarized light (the polarization direction of which differs from that at the time of emission by 90°), and this linearly polarized light passes through the polarization beam splitter PBS and is guided to the objective servo photodetector PD through a detection lens AS.

The objective lens OB is moved in the optical axis direction on the basis of a signal from the objective servo photodetector PD such that the wavelength selective reflection layer 5 reaches the focal point position of the servo beam (focus servo), and the objective lens OB is moved in a perpendicular direction to the optical axis so that the servo mark matches the condensing position (tracking servo). This method is identical to a conventional optical disk servo technique, and in the focus servo, an astigmatism method may be used, for example, while in the tracking servo, a push-pull method may be used, for example.

For example, when an astigmatism method is used, a four-split photodetector (the objective servo photodetector PD) and an astigmatism optical element (not shown) are employed. As shown in FIG. 30, one of the centers of the objective servo photodetector PD of the four-split photodetector is constituted by light-receiving elements 1a to 1d having a light-receiving surface divided into four equal parts for receiving a beam. The directions of the four dividing lines correspond to the radial direction of the disk and a tangential direction of the track. The objective servo photodetector PD is set such that a light spot during focusing forms a circle centering on the center of intersection of the divided light-receiving elements 1a to 1d.

The objective servo signal processing circuit 28a generates various signals in accordance with the respective output signals of the light-receiving elements 1a to 1d of the four-split photodetector. If the respective output signals of the light-receiving elements 1a to 1d are set in order as Aa to Ad, then a focus error signal FE is calculated to FE=(Aa+Ac)−(Ab+Ad), and a tracking error signal TE is calculated to TE=(Aa+Ad)−(Ab+Ac). These signals are supplied to the objective servo signal processing circuit 28a. Thus, the gap between and the positions of the recording medium 2 and the objective lens OB can be maintained appropriately.

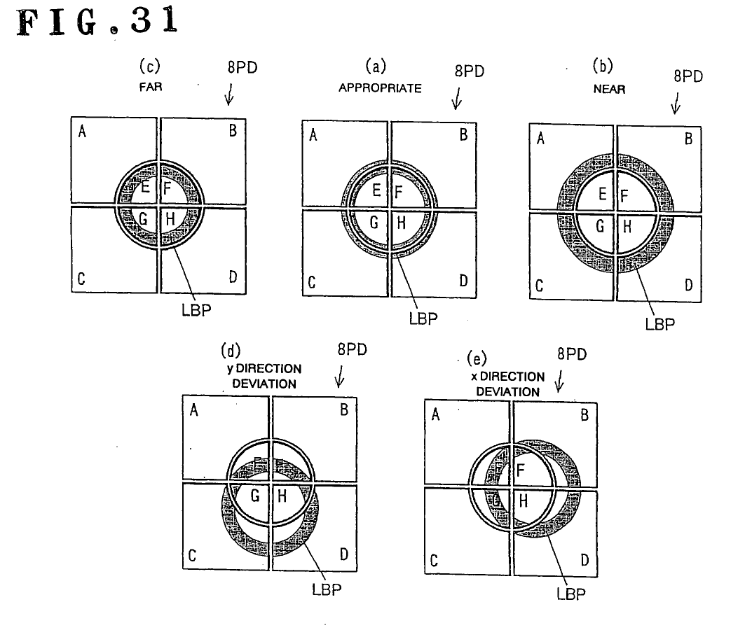

Further, the annular beam that passes through the annular ½ wavelength plate ½λ is used to adjust the relative positions of the objective lens OB and the parabolic mirror PM. As described above, this annular beam is guided onto the reflection servo photodetector 8PD. The reflection servo photodetector 8PD is divided into 8 parts, as shown in FIG. 31. Hence, when the parabolic mirror PM is positioned appropriately, an annular beam pattern LBP is positioned on a circle dividing line, as shown in FIG. 31A, and therefore an equal amount of light enters light-receiving elements on the outer peripheral side (A+B+C+D) and the inner peripheral side (E+F+G+H) of the reflection servo photodetector 8PD. As the parabolic mirror PM approaches the objective lens OB, the amount of light entering the outer peripheral side light-receiving elements increases, as shown in FIG. 31B, and conversely, as the parabolic mirror PM moves away from the objective lens OB, the amount of light entering the inner peripheral side light-receiving elements increases, as shown in FIG. 31C. Hence, by adjusting the position of the parabolic mirror PM in the optical axis direction such that an error signal according to which an optical axis direction (z direction) error signal FES=(A+B+C+D)−(E+F+G+H) reaches zero level, the gap between the parabolic mirror PM and the objective lens OB can be maintained appropriately.

Further, when the parabolic mirror PM shifts in a perpendicular direction (xy direction) to the optical axis, the annular beam pattern on the reflection servo photodetector 8PD shifts as shown in FIGS. 31D and 31E. For example, using TRKy=(A+B+E+F)−(C+D+G+H) as an error signal in relation to y direction bias of the parabolic mirror PM, and using TRKx=(A+C+E+G)−(B+D+F+H) as an error signal in relation to x direction bias of the parabolic mirror PM, xy adjustment of the parabolic mirror PM can be performed such that the respective error signals reach zero level. Further, TRKy=(A+B+G+H)−(C+D+E+F) and TRKx=(A+C+F+H)−(B+D+E+G) may be used instead of the TRKy and TRKx described above.

When an incline occurs in the parabolic mirror PM, an error signal may be reduced to zero level using similar xy direction adjustment. As long as the spot on the reflection servo photodetector 8PD is in the state shown in FIG. 31A, the pattern on the spatial light modulator SLM is formed correctly into an image on the image sensor ISR even if the tilt and eccentricity of the parabolic mirror PM are not zero, and hence no problems occur. Although wiring is not shown in the drawing, these signals are supplied to the reflection servo signal processing circuit 28b.

[Recording and Reproduction Operation of Hologram Device]

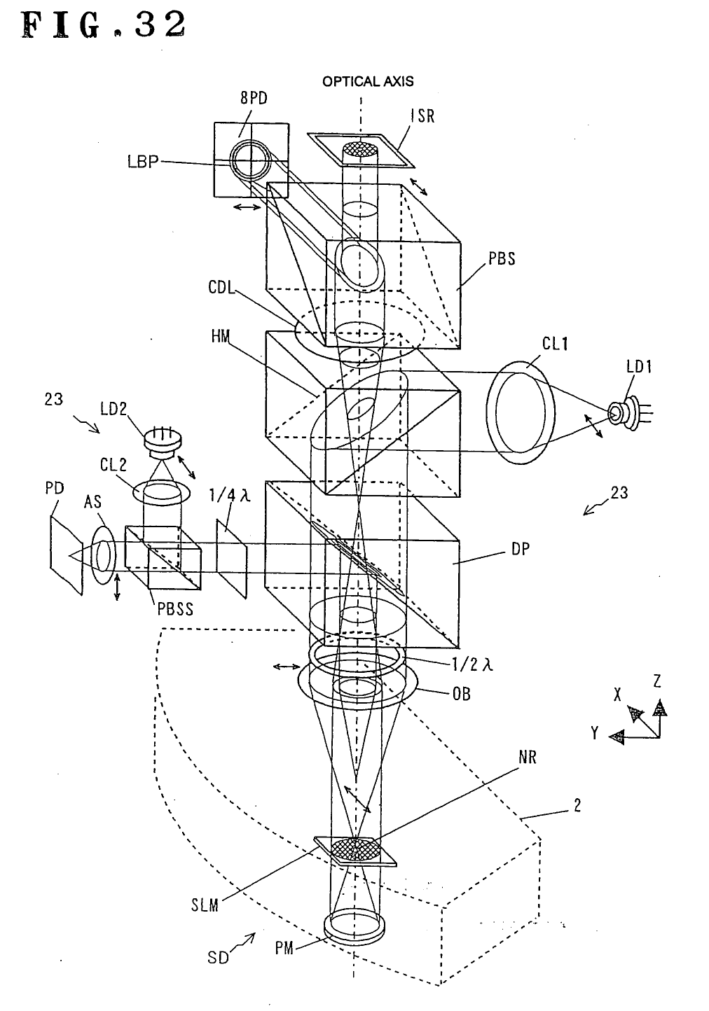

A recording and reproduction method employing a hologram device shown in FIG. 32 for recording or reproducing information by irradiating the disk 2 with a light beam will now be described.

First, in a step 1, the servo laser LD2 is activated and the relative positions of the disk 2 and the objective lens OB are adjusted (focus and tracking). At this time, the recording and reproduction laser LD1 is extinguished or activated at low power such that no hologram is recorded. Focus servo of a laser spot for controlling the position of the objective lens OB (the distance between the objective lens OB and the disk 2) in a perpendicular direction (z direction) on the main surface of the disk 2 is performed by the objective lens driving portion.

Next, in a step 2, by activating the recording and reproduction laser LD1 at low power (if already activated, the recording and reproduction laser LD1 is left as is) and setting the pattern of the spatial light modulator SLM to be fully permeable, the annular spot forms an image on the reflection servo photodetector 8PD. Hence, position control (of the distance between the objective lens OB and, the parabolic mirror PM) is performed by moving the parabolic mirror PM such that the image is set in the correct position. Here, the parabolic mirror PM and spatial light modulator SLM are driven and adjusted integrally. Since the output of the recording and reproduction laser LD1 is reduced, no hologram is recorded at this stage. By means of this adjustment, the objective lens OB, disk 2, and parabolic mirror PM are positionally adjusted to predetermined positions.

In a step 3, a recording data pattern is displayed on the spatial light modulator SLM, and the output of the recording and reproduction laser LD1 is increased such that a hologram is recorded on the recording layer of the disk 2. At this time, the signal light that passes through the disk 2 is formed into an image on the image sensor ISR by the objective lens OB and the condenser lens CDL, and therefore a mixed image comprising the image of the pattern on the spatial light modulator SLM and a reproduced image of the hologram that has just been recorded is formed on the image sensor ISR.

In a step 4, when recording is complete, the recording and reproduction laser LD1 is extinguished (or reduced to low power), and the disk 2 (or the pickup) is moved relatively to approximately the position of the next servo mark by a driving mechanism so as to overlap the optical axis. Precise positioning is performed by a servo mechanism using a servo beam, and therefore the position to which the disk 2 is moved may be approximate.

By repeating steps 1 to 4, holograms are recorded successively on the disk 2.

Next, the flow of reproduction will be described.

First, in a step 11, the servo laser LD2 shown in FIG. 32 is activated and the relative positions of the disk and the objective lens OB are adjusted (focus, tracking). At this time, the recording and reproduction laser is extinguished or activated at low power such that no hologram is recorded.

In a step 12, the spatial light modulator SLM is set in a fully blocking pattern while the recording and reproduction laser LD1 is activated at low power (reproduction output). Thus, light from the rear surface side of the disk 2 is blocked, and only the reference light is emitted onto the disk 2. Hologram reproduction light is emitted from the front surface of the disk 2 toward the objective lens OB. At this time, reproduction light produced by the reference light in the inner peripheral portion of the annular ½ wavelength plate ½λ forms an image on the image sensor ISR, and reproduction light produced by the reference light that has passed through the annular ½ wavelength plate ½λ forms an image on the reflection servo photodetector 8PD. Here, only the image on the image sensor ISR is used. The image on the image sensor ISR is transmitted to the signal processing circuit and formed into a reproduction signal.

In a step 13, the disk 2 is moved to approximately the position of the next servo mark by a driving mechanism so as to overlap the optical axis. Precise positioning is performed by a servo mechanism using a servo beam, and therefore the position to which the disk 2 is moved may be approximate.

By repeating steps 11 to 13, the holograms recorded on the disk 2 are successively reproduced. Note that in the processing of the steps 11 to 13, the recording and reproduction laser may be activated or extinguished.

In the embodiment described above, the annular ½ wavelength plate ½λ is used, but similar effects are exhibited when the ¼ wavelength plate ¼λ is disposed with a similar ring-shaped ring zone instead of the ½ wavelength plate ½λ, and a servo beam component is separated from the reproduction light by the polarization beam splitter PBS using the outer peripheral beam ring of circularly polarized light.

The present invention may also be applied to the technique of Patent Document 2 described above, whereby similar effects are exhibited.

### OTHER EMBODIMENTS RELATING TO WAVELENGTH PLATE

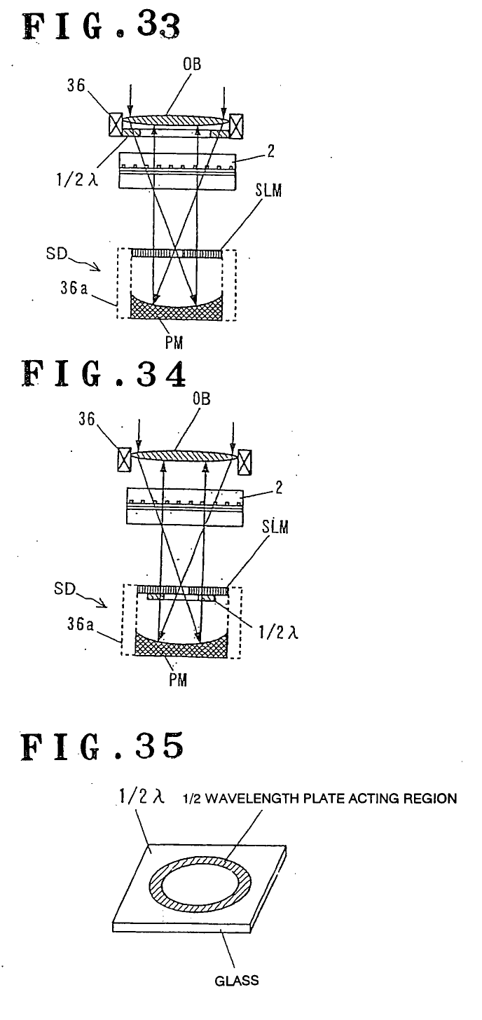

In the pickup of the hologram device shown in FIG. 24, the ½ wavelength plate ½λ is disposed in front (on the light source side) of the objective lens OB, but the present invention is not limited thereto. The wavelength plate does not have to be placed in front of the objective lens, and may be placed at the rear of the objective lens OB (on the light emission side), as shown in FIG. 33, or in front of the spatial light modulator SLM (on the parabolic mirror PM side), as shown in FIG. 34. Needless to say, the ½ wavelength plate ½λ may also be disposed at the rear of the spatial light modulator SLM (on the recording medium 2 side) (not shown). Thus, the phase plate varies the polarization state of all or a part of the beam components of a light beam passing through a circle defined by the effective diameter of the objective lens OB and the vicinity thereof without varying the polarization state of the light beam in the interior thereof.

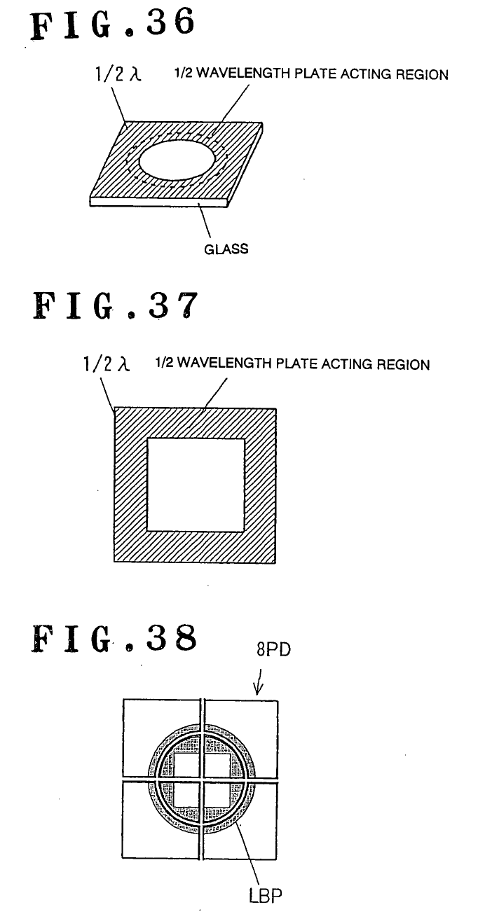

Further, in the embodiment described above, the ring-shaped ½ wavelength plate ½λ is used (FIG. 25), but the ½ wavelength plate ½λ may be formed by forming the ½ wavelength plate as a ring-shaped ring zone on a transparent glass parallel plate, as shown in FIG. 35, or as an optical element exhibiting a ½ wavelength plate action in a ring-shaped region (ring zone). In other words, the phase plate has an external region for varying the polarization state of all or a part of the beam components of a light beam passing through a circle defined by the effective diameter of the objective lens OB and the vicinity thereof, and the exterior region defines an interior region in which the polarization state of a light beam positioned on the optical axis side is not varied. Furthermore, in actuality, the ½ wavelength plate ½λ may be an optical in which the entire outer side thereof, including the ring zone, serves as the ½ wavelength plate region, as shown in FIG. 36. The wavelength plate region (exterior region) includes a circle or a polygon centering on the optical axis or an enclosed boundary belt surrounding an interior region.

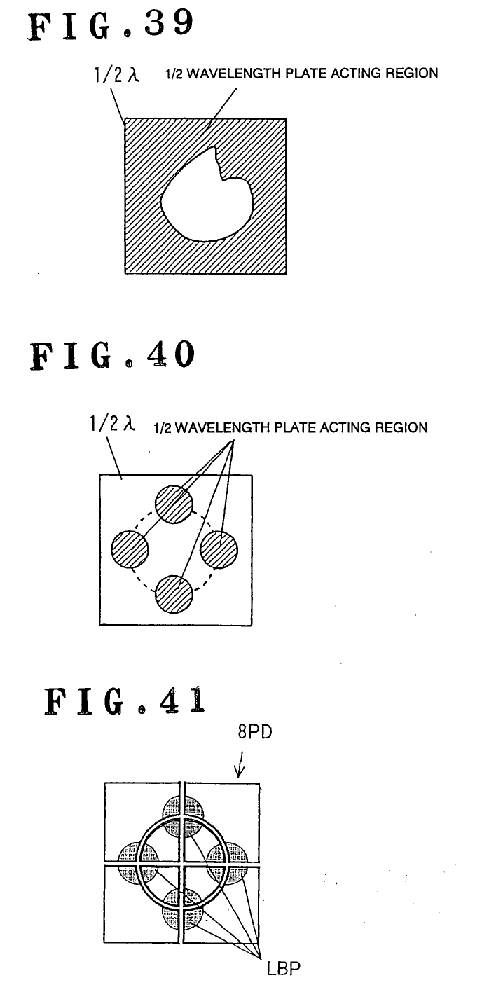

In other words, the ½ wavelength plate ½λ need not be a “circle”. As shown in FIG. 37, the ½ wavelength plate may be square. At this time, a spot RP on the reflection servo photodetector 8PD is formed as shown in FIG. 38, and the dividing lines of the reflection servo photodetector 8PD should be determined such that the light quantity on all of the light-receiving elements of the reflection servo photodetector 8PD is equal when there is no deviation in the position of the parabolic mirror PM. As long as the light quantity on the light-receiving elements is determined to be equal, the ½ wavelength plate region may take a random shape, as shown in FIG. 39.

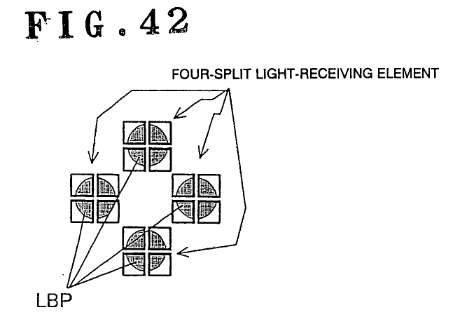

In another embodiment, the shape of the spot does not have to be continuous in the circumferential direction. For example, a fragmented region within the light beam may be used as the ½ wavelength plate region, as shown in FIG. 40. In the example shown in FIG. 40, four circular regions are arranged symmetrically, and therefore the previous eight-split reflection servo photodetector 8PD may be used, as shown in FIG. 41, or a light-receiving element (four-split light-receiving element) may be disposed in a beam pattern LBP of each individual region, as shown in FIG. 42. Thus, the wavelength plate region (exterior region) may be constituted by a plurality of regions disposed at a remove from each other in ring form about the optical axis center.

### OTHER EMBODIMENTS USING COMPONENTS OTHER THAN THE WAVELENGTH PLATE

In the examples described previously, a ½ wavelength plate is used as a phase plate for obtaining a servo spot, and the light components passing through the ½ wavelength plate are separated by a polarization beam splitter and led to a reflection servo photodetector.

In the following example, the servo optical spot is separated without using a ½ wavelength plate.

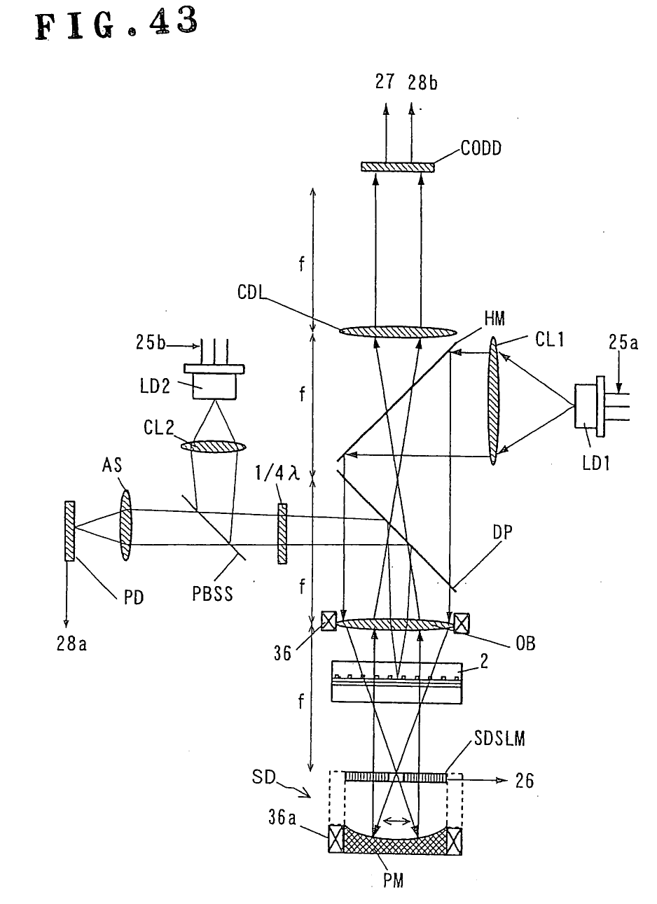

FIG. 43 shows the constitution of a pickup according to another embodiment.

The pickup of this embodiment is identical to those of the previous embodiments except that in place of the polarization beam splitter PBS, image sensor ISR, reflection servo photodetector 8PD, ½ wavelength plate ½λ, and spatial light modulator SLM, a signal detection compound optical detection device CODD and a servo detection spatial light modulator SDSLM, which combine these components, are used. In so doing, a reduction in the number of components can be achieved.

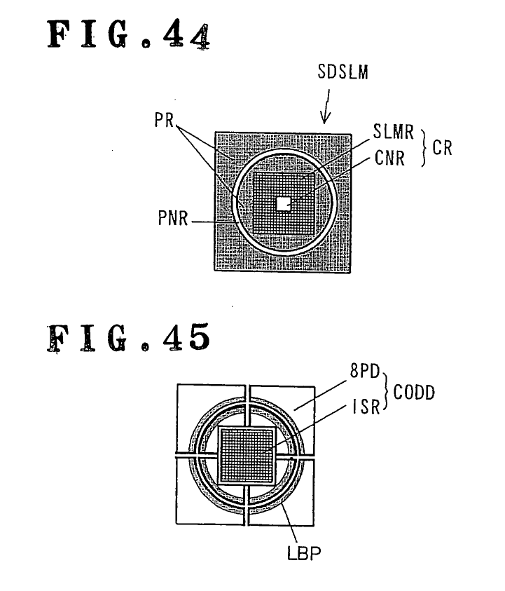

As shown in FIG. 44, the servo detection spatial light modulator SDSLM is divided into a central region CR including the optical axis and a peripheral light shielding region PR on the periphery of the central region CR and not including the optical axis. The central region CR is constituted by a transmission matrix liquid crystal device, and the transmission matrix liquid crystal device is constituted by a spatial light modulation region SLMR and a central non-modulating light transmission portion CNR surrounded by the spatial light modulation region SLMR and including the optical axis. In the peripheral light shielding region PR, a servo light transmission portion PNR for transmitting the luminous flux that passes therethrough without subjecting the luminous flux to modulation is provided concentrically with the optical axis in the form of a ring-shaped opening, for example. The non-modulating light transmission portion CNR and the servo light transmission portion PNR may be constituted by a physically penetrating opening or a transparent material filling the opening. Thus, when light passes through the servo detection spatial light modulator SDSLM, the servo detection spatial light modulator SDSLM separates the light into reference light, signal light (modulated light) or reproduction light, and servo detection reference light on the same axis. Further, in this embodiment, the servo detection spatial light modulator SDSLM may be constituted in its entirety by a transmission matrix liquid crystal device, whereby a spatial light modulation region SLMR for displaying a recording pattern, a light transmission portion NR in the interior thereof, and a servo light transmission portion PNR in a light shielding region on the periphery of the spatial light modulation region SLMR and light transmission portion NR are displayed as non-modulating light transmission regions by a connected control circuit. In other words, the light transmission portion NR and the servo light transmission portion PNR may be displayed as a spatial light modulator SLM in a light transmission state during hologram recording.

As shown in FIG. 45, in the signal detection compound optical detection device CODD, an image sensor part ISR for receiving reproduction light is formed in a central portion including the optical axis in the same plane, and a light-receiving surface of an eight-split reflection servo photodetector 8PD having a split that enables generation of the servo error described above is disposed in a peripheral portion thereof and concentrically therewith.

According to any of the embodiments described above, in a light beam position control method in an optical pickup device, a reflection portion for reflecting and returning a light beam toward an irradiation optical system for irradiating a recording medium is disposed opposite the irradiation optical system, on a common optical axis therewith, and at a remove therefrom, a central light component that passes through the optical axis and a peripheral light component having a different modulation state to the central light component are generated separately from the light beam and all or a part of the periphery of the central light component, respectively, and the peripheral light component of the return light of the optical beam is extracted and guided to a photodetector. Thus, the reflection portion can be positioned accurately relative to the light beam on the basis of a photoelectric conversion output from the photodetector.

1. An optical pickup device having an irradiation optical system for condensing a light beam using an objective lens, comprising:
a reflection portion disposed opposite said irradiation optical system, on a common optical axis therewith, and at a remove therefrom, for reflecting and returning said light beam toward said irradiation optical system;
a phase plate disposed on said optical axis, for generating light on said optical axis, and light having a modified polarization state on all or a part of the periphery of said light on said optical axis, separately from said light beam;
a detection optical system disposed on said optical axis, for extracting said light having a modified polarization state from return light of said light beam and guiding said extracted light to a photodetector; and
a reflection portion driving portion for positioning said reflection portion on the basis of a photoelectric conversion output from said photodetector.

2. The optical pickup device according to claim 1, wherein said phase plate comprises an exterior region for varying the polarization state of all or a part of a beam component of said light beam that passes through a circle defined by an effective diameter of said objective lens and the vicinity thereof, and
said exterior region defines an interior region that does not vary the polarization state of said light beam positioned on said optical axis side.

3. The optical pickup device according to claim 2, wherein said exterior region includes a circle or polygon centering on said optical axis or an enclosed boundary belt surrounding said interior region.

4. The optical pickup device according to claim 2, wherein said exterior region is constituted by a plurality of regions disposed at a remove from each other in a ring shape centering on said optical axis.

5. The optical pickup device according to claim 2, wherein said reflection portion returns said light beam through said interior region of said phase plate.

6. The optical pickup device according to claim 1, wherein said reflection portion returns said light beam at a different numerical aperture to a numerical aperture of said objective lens.

7. The optical pickup device according to claim 1, wherein said reflection portion returns said light beam as substantially parallel beams.

8. The optical pickup device according to claim 1, wherein said reflection portion includes a concave mirror.

9. The optical pickup device according to claim 8, wherein said reflection portion includes a parabolic mirror.

10. The optical pickup device according to claim 1, wherein said reflection portion includes an assembly of a plane mirror and an optical element having a convex lens action, which are disposed parallel to each other and coaxially.

11. The optical pickup device according to claim 10, wherein said optical element having a convex lens action comprises a diffraction optical element having a convex lens action.

12. The optical pickup device according to claim 10, wherein said optical element having a convex lens action comprises a convex lens.

13. The optical pickup device according to claim 1, wherein said reflection portion includes a spatial light modulator disposed on said optical axis and an assembly of a diffraction optical element having a convex lens action, which is formed integrally with said spatial light modulator, and a plane mirror disposed at a remove from, and parallel to, said diffraction optical element.

14. The optical pickup device according to claim 1, wherein a light reception portion of said photodetector includes is constituted by four independent central light-receiving elements disposed close to each other with two orthogonal dividing lines serving as boundary lines, for receiving a beam component that passes through said boundary belt about an intersection between said dividing lines, and four outside light-receiving elements disposed close to each other on respective outer sides of said four central light-receiving elements, and
a servo signal processing circuit connected to said four central light-receiving elements and said four outside light-receiving elements is provided.

15. The optical pickup device according to claim 14, wherein said servo signal processing circuit generates a difference between an output sum of said four central light-receiving elements and an output sum of said four outside light-receiving elements as an error signal of a distance to said reflection portion.

16. The optical pickup device according to claim 14, wherein said servo signal processing circuit generates a difference between an output sum of two of said four central light-receiving elements and two of said four outside light-receiving elements on one side of one of said two dividing lines and an output sum of the other light-receiving elements as an error signal from said optical axis of said light beam.

17. The optical pickup device according to claim 1, wherein said detection optical system includes a polarization beam splitter.

18. The optical pickup device according to claim 1, wherein said phase plate is comprises a ½ wavelength plate.

19. The optical pickup device according to claim 1, wherein said phase plate comprises a ¼ wavelength plate.

20. The optical pickup device according to claim 1, wherein said irradiation optical system and said reflection portion are disposed so as to sandwich a transmission type recording medium about said optical axis.

21. The optical pickup device according to claim 1, wherein said reflection portion driving portion moves said reflection portion in at least an extension direction of an optical axis of said irradiation optical system and a perpendicular direction to said optical axis.

22. The optical pickup device according to claim 1, wherein an objective lens driving portion is provided for driving said objective lens,
said detection optical system includes a four-split photodetector and an astigmatism optical element,
a light reception portion of said four-split photodetector is constituted includes by four independent light-receiving elements disposed close to each other with two orthogonal dividing lines serving as boundary lines, for receiving a beam component that passes through said boundary belt about an intersection between said dividing lines, and
a servo signal processing circuit is provided for generating a difference between an output sum of two diagonally opposing light-receiving elements of said four light-receiving elements and an output sum of the other light-receiving elements as a distance error signal.

23. A light beam position control method in an optical pickup device having an irradiation optical system for condensing a light beam using an objective lens, comprising:
disposing a reflection portion for reflecting and returning a light beam toward said irradiation optical system opposite said irradiation optical system, on a common optical axis therewith, and at a remove therefrom;
generating separately, from said light beam, a central light component that passes through said optical axis, and a peripheral light component having a different polarization state to said central light component from all or a part of the periphery of said central light component, respectively;
extracting said peripheral light component from return light of said optical beam and guiding said extracted peripheral light component to a photodetector; and
positioning said reflection portion on the basis of a photoelectric conversion output from said photodetector.

24. The light beam position control method according to claim 23, wherein a light reception portion of said photodetector includes four independent central light-receiving elements disposed close to each other with two orthogonal dividing lines serving as boundary lines, for receiving said peripheral light component about an intersection between said dividing lines, and four outside light-receiving elements disposed close to each other on respective outer sides of said four central light-receiving elements.

25. The light beam position control method according to claim 24, wherein said servo signal processing circuit generates a difference between an output sum of said four central light-receiving elements and an output sum of said four outside light-receiving elements as an error signal of a distance to said reflection portion.

26. The light beam position control method according to claim 24, wherein said servo signal processing circuit generates a difference between an output sum of two of said four central light-receiving elements and two of said four outside light-receiving elements on one side of one of said two dividing lines and an output sum of the other light-receiving elements as an error signal from said optical axis of said light beam.

27. The light beam position control method according to claim 23, wherein said irradiation optical system or said reflection portion includes a phase plate having an exterior region for varying the polarization state of all or a part of a beam component of said light beam that passes through a circle defined by an effective diameter of said objective lens and the vicinity thereof and an interior region defined by said exterior region, which does not vary the polarization state of said optical beam positioned on said optical axis side, and
said phase plate generates separately, from said light beam, a central light component that passes through said optical axis, and a peripheral light component having a different polarization state to said central light component from all or a part of the periphery of said central light component, respectively.

28. The light beam position control method according to claim 23, wherein said reflection portion includes a spatial light modulator disposed on said optical axis, and said spatial light modulator generates separately, from said light beam, a central light component that passes through said optical axis, and a peripheral light component having a different modulation state to said central light component from all or a part of the periphery of said central light component, respectively.

29. The light beam position control method according to claim 28, wherein said spatial light modulator includes a central spatial light modulation region includes a transmission matrix liquid crystal device disposed on said optical axis for generating modulated light by modulating said light beam in accordance with recording information, and a peripheral transmission region disposed on the periphery of said spatial light modulation region for transmitting said light beam unmodulated.

30. The light beam position control method according to claim 28, wherein said peripheral transmission region includes a penetrating opening or a transparent material.

31. The light beam position control method according to claim 28, wherein said peripheral transmission region includes a transmission matrix liquid crystal device, and during recording, said peripheral transmission region enters a light transmission state.

32. The light beam position control method according to claim 28, comprising:
a servo system for performing servo control using said light beam that passes through said peripheral transmission region;
an image detection region disposed on an optical axis of said servo system for detecting light other than said light beam that passes through said peripheral transmission region; and
a servo light detection region disposed on the periphery of said servo light detection region for receiving said light beam that passes through said peripheral transmission region.
